(19) United States
(12) Patent Application Publication
(10) Pub. No.: US 2015/0294365 A1
(43) Pub. Date: Oct. 15, 2015

(54) Systems and Methods for Creation and Transmission of Emails with Integral Advertisements via an Email Marketing System

(71) Applicant: Batalha Holdings Limited Liability Company, Bloomsbury, NJ (US)

(72) Inventor: Michael Andrew Batalha, Branchburg, NJ (US)

(73) Assignee: Batalha Holdings Limited Liability Company, Bloomsbury, NJ (US)

(21) Appl. No.: 14/522,499

(22) Filed: Oct. 23, 2014

Related U.S. Application Data
(60) Provisional application No. 61/978,273, filed on Apr. 11, 2014.

(51) Int. Cl. G06Q 30/02; G06Q 10/10

(52) U.S. Cl. CPC G06Q 30/0269; G06Q 10/107

(57) ABSTRACT

Systems and methods for creation and transmission of emails with integral advertisements via an email marketing system, wherein advertisements are selected based on a variety of factors including, without limitation, rate information and geographical location.

### CROSS-REFERENCE TO RELATED APPLICATIONS

This application claims the benefit of the U.S. provisional patent application entitled “Systems and Methods for Creation and Transmission of Emails with Integral Advertisements via an Email Marketing System” having Ser. No. 61/978,273, filed Apr. 11, 2014, which is hereby incorporated by reference in its entirety as if fully set forth herein.

### COPYRIGHT NOTICE

A portion of the disclosure of this patent document contains material which is or may be subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### BACKGROUND OF THE INVENTION

Embodiments of the present invention generally relate to systems and methods for creation and transmission of emails with integral advertisements via an email marketing system. More specifically, the present invention relates to systems and methods for creation and transmission of emails with integral advertisements via an email marketing system, wherein advertisements are selected based on a variety of factors including, without limitation, rate information and geographical location.

### BRIEF SUMMARY OF THE INVENTION

Briefly stated, in one aspect of the present invention, systems and methods for creation and transmission of emails with integral text and/or graphical advertisements via an email marketing system, wherein advertisements are selected based on a variety of factors including, without limitation, rate information and geographical location, are provided.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1A depicts a flowchart of one method for creating an email with both email content and integral text advertisements for transmission to a plurality of recipients via an email marketing system in accordance with one embodiment of the present invention;

FIG. 1B depicts an exemplary email including both content and text and/or graphical advertisements created by the method depicted in FIG. 1A and/or FIG. 7/FIG. 10 in accordance with multiple embodiments of the present invention;

FIG. 2A depicts a schematic view of an exemplary network environment within which various embodiments of the present invention may be implemented;

FIGS. 2B-2D depict exemplary databases for use in accordance with one embodiment of the present invention;

FIG. 3 depicts a block diagram of an exemplary computing device with which various embodiments of the present invention may be implemented;

FIG. 4 depicts a flowchart of one method for allowing a user to create an ad campaign in accordance with one embodiment of the present invention;

FIG. 5 depicts an exemplary data input screen for selecting categories during creation of an ad campaign;

FIG. 6 depicts an exemplary data input screen for entering various data during creation of an ad campaign;

FIG. 7 depicts a flowchart of method for allowing a user to create an email campaign with or without integral text or graphical advertisements in accordance with one embodiment of the present invention;

FIG. 8 depicts a flowchart of one method of automatically selecting advertisements to be appended to, or included in, an email in accordance with one embodiment of the present invention;

FIGS. 9A-9D depict flowcharts of multiple methods of automatically updating an email recipient's rate information in accordance with one embodiment of the present invention; and

FIG. 10 depicts a flowchart for the display of a graphical advertisements in accordance with one embodiment of the present invention.

### DETAILED DESCRIPTION OF THE INVENTION

Certain terminology may be used in the following description for convenience only and is not limiting. The words “lower” and “upper” and “top” and “bottom” designate directions in the drawings to which reference is made. The terminology includes the words above specifically mentioned, derivatives thereof and words of similar import.

Where a term is provided in the singular, the inventors also contemplate aspects of the invention described by the plural of that term. As used in this specification and in the appended claims, the singular forms “a”, “an” and “the” include plural references unless the context clearly dictates otherwise, e.g., “an advertisement” may include a plurality of advertisements. Thus, for example, a reference to “a method” includes one or more methods, and/or steps of the type described herein and/or which will become apparent to those persons skilled in the art upon reading this disclosure.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods, constructs and materials are now described. All publications mentioned herein are incorporated herein by reference in their entirety. Where there are discrepancies in terms and definitions used in references that are incorporated by reference, the terms used in this application shall have the definitions given herein.

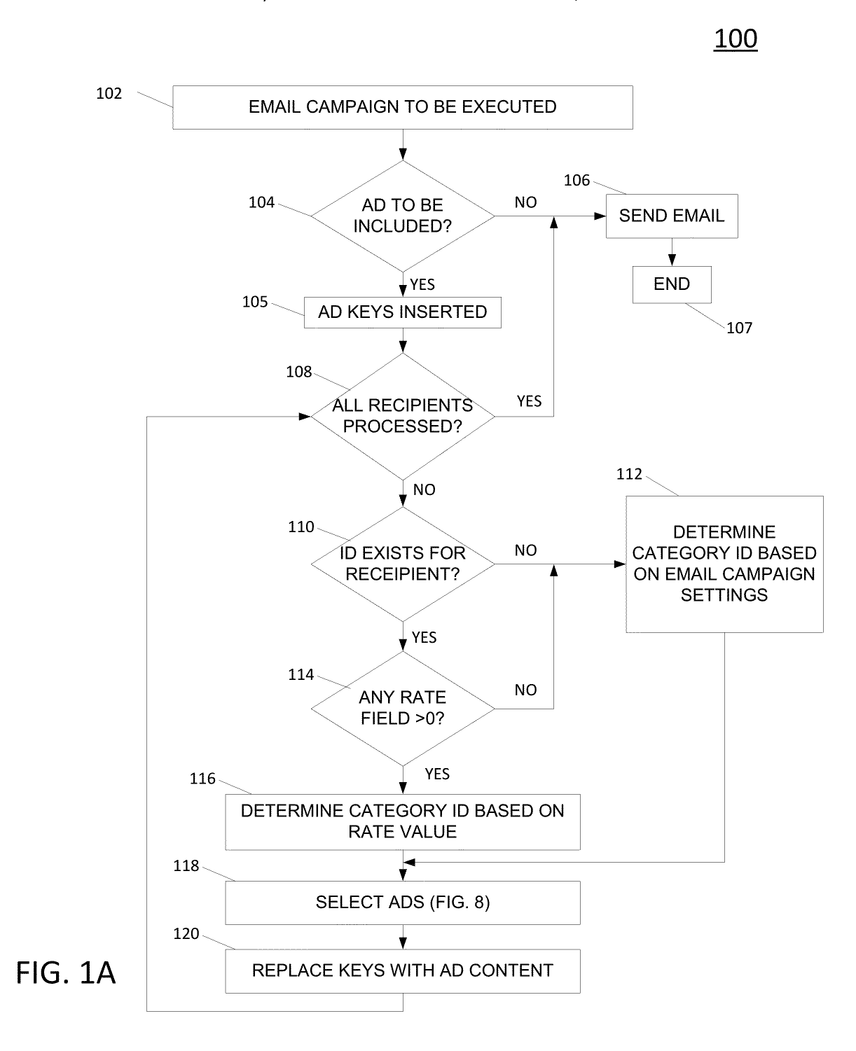

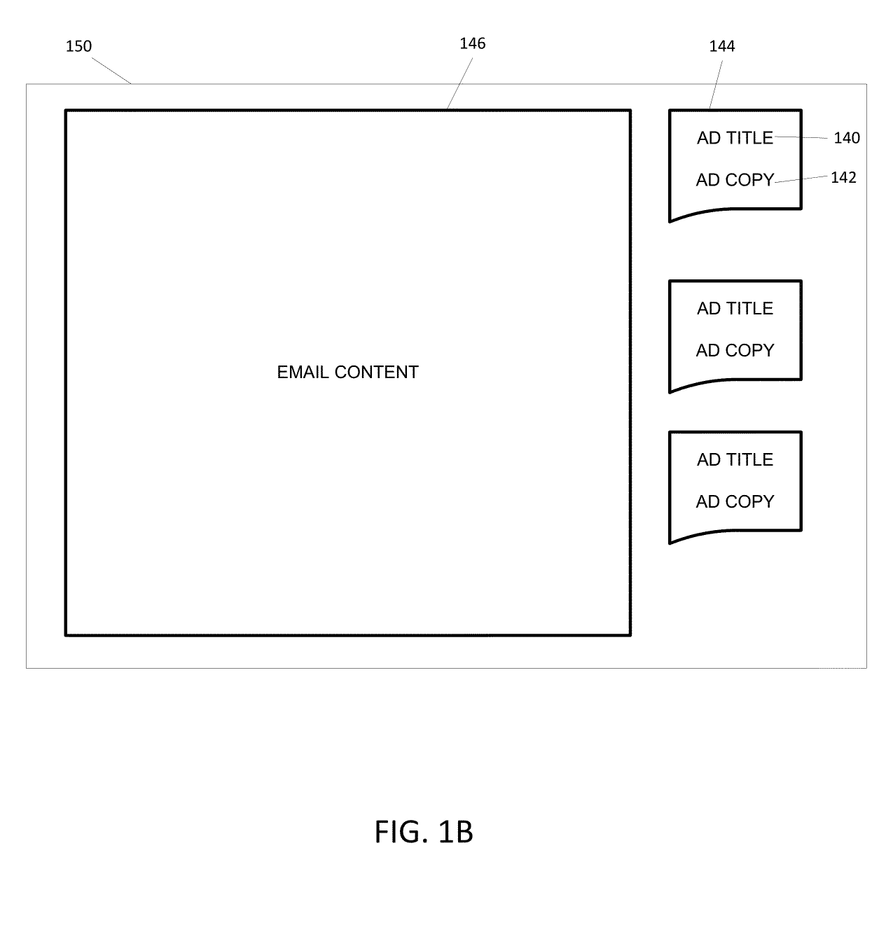

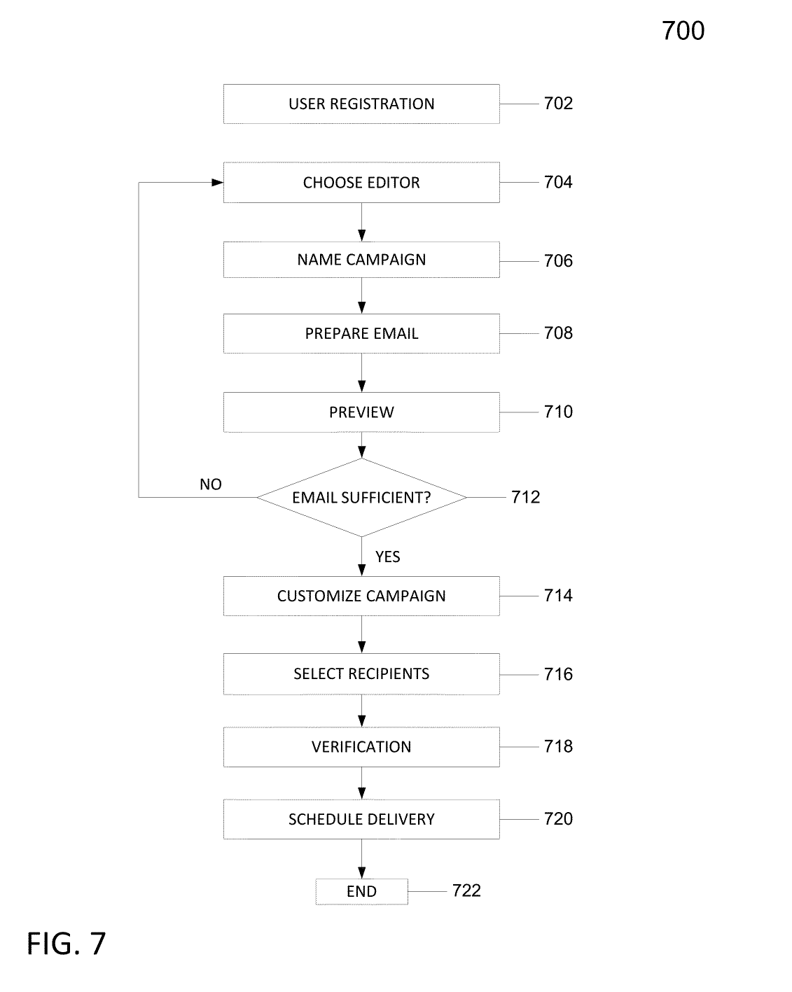

Referring first to FIG. 1A, depicted is a flowchart of one method for creating an email with integral advertisements via a typical email marketing system in accordance with one embodiment of the present invention. Email marketing systems are known in the art and include, without limitation, Emercury (emercury.net) and Constant Contact (constantcontact.com). Such email marketing systems allow users to create e-mail campaigns in which various content may be sent to a large quantity of e-mail recipients simultaneously. One method of creating such an e-mail campaign is displayed with reference to FIG. 7.

As discussed in greater detail herein, the present invention allows an advertiser-user to utilize the benefits of an e-mail marketing system for efficient and cost effective advertising. In one embodiment of the present invention, the advertiser-user's advertisements are included in the large quantity of emails sent by someone other than the user as part of an e-mail campaign. That is, the user is able to send the advertisements to all recipients of another entity's e-mail campaign utilizing the systems and methods of the present invention. In exchange, the sender of the e-mail campaign (i.e., the emailer-uer) may be reimbursed in some form for the transmission of the advertisements or otherwise rewarded. For example, in one embodiment of the present invention, the emailer-user may receive a discount to the cost of generating and sending the e-mail campaign. In another embodiment, the emailer-user receives a cash value for each advertisement transmitted in the emailer-user's campaign that is opened and/or clicked by a user. For example, in the depicted embodiment, the emailer-user receives 67% of the CPC paid by the advertiser-user (whenever the advertisement is clicked by the email recipient) in exchange for sending the advertisement with the emailer-user's email content. However, alternate percentages and/or alternate methods of compensating or otherwise rewarding the emailer-user may be substituted without departing from the scope hereof.

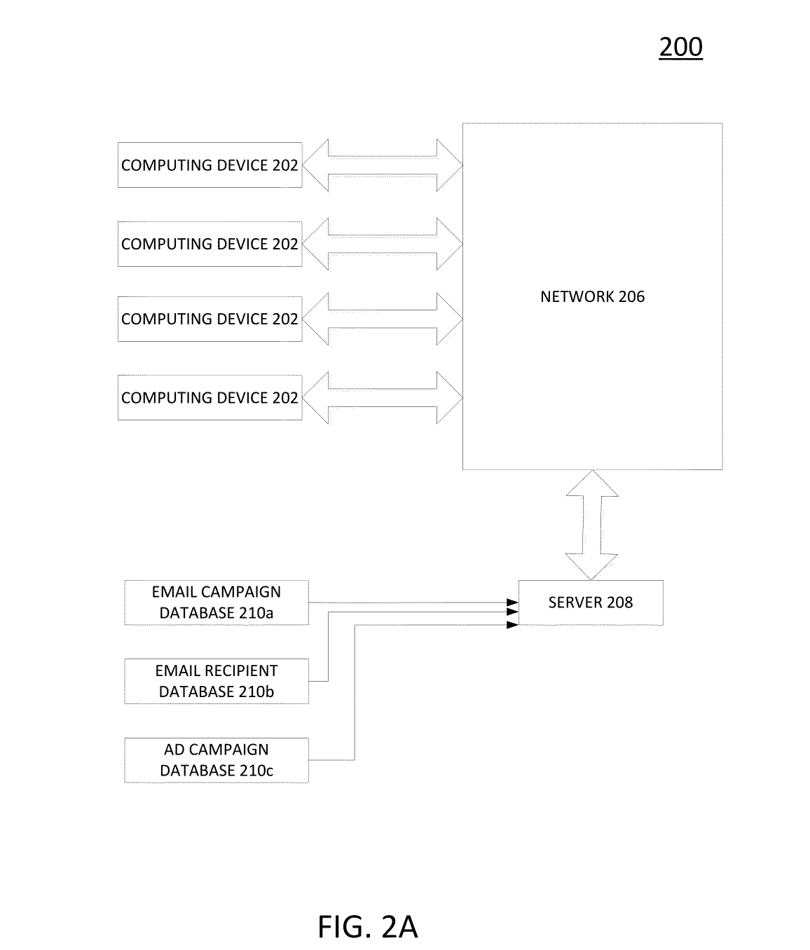

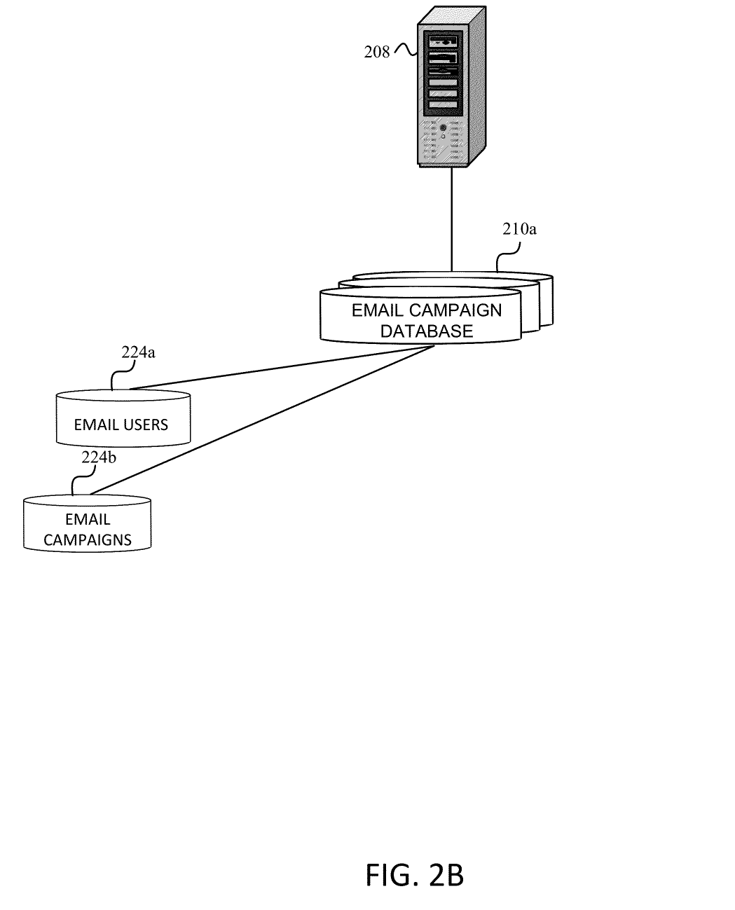

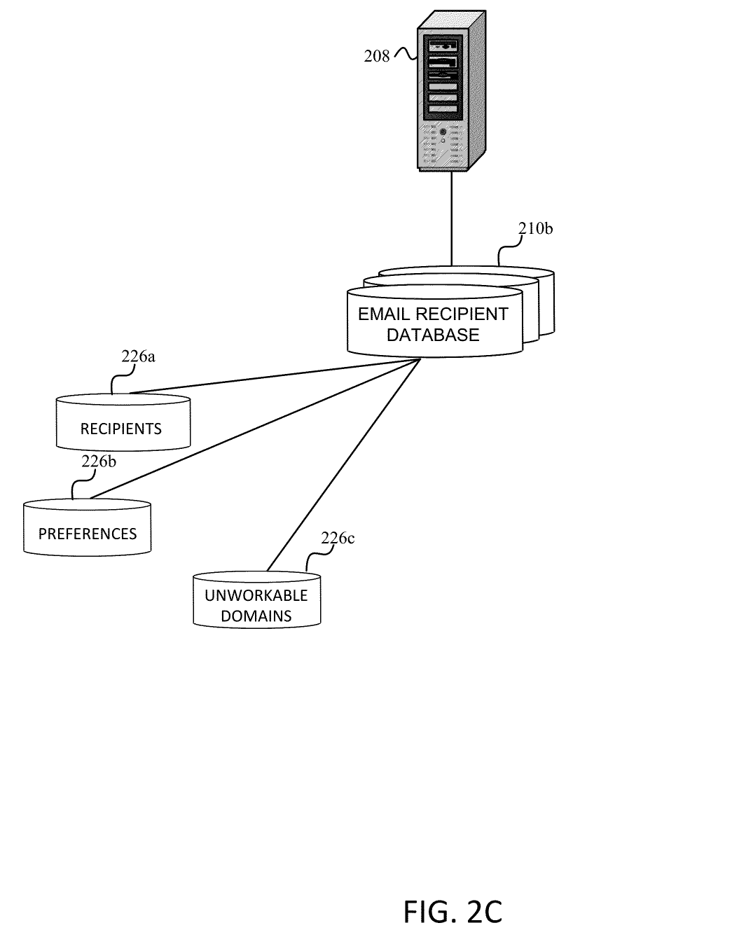

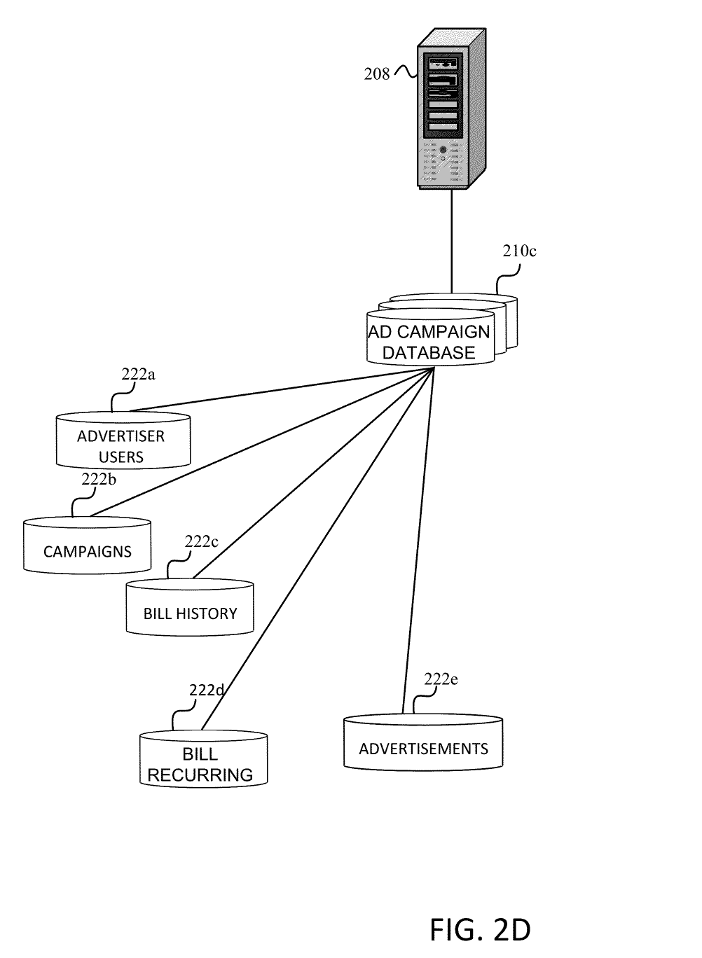

FIGS. 2A through 2D set forth herein represent an exemplary computing system environment and an exemplary database, respectively, for allowing a user of system 200 to perform the methods described with respect to FIGS. 1 through 10. The depicted computing system environment is only one example of a suitable computing environment and is not intended to suggest any limitation as to the scope of use or functionality. Numerous other general purpose or special purpose computing system environments or configurations may be used. Examples of well-known computing systems, environments, and/or configurations that may be suitable for use include, but are not limited to, personal computers (“PCs”), server computers, handheld or laptop devices, multi-processor systems, microprocessor-based systems, network PCs, minicomputers, mainframe computers, cell phones, tablets, embedded systems, distributed computing environments that include any of the above systems or devices, and the like.

Computer-executable instructions such as program modules executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

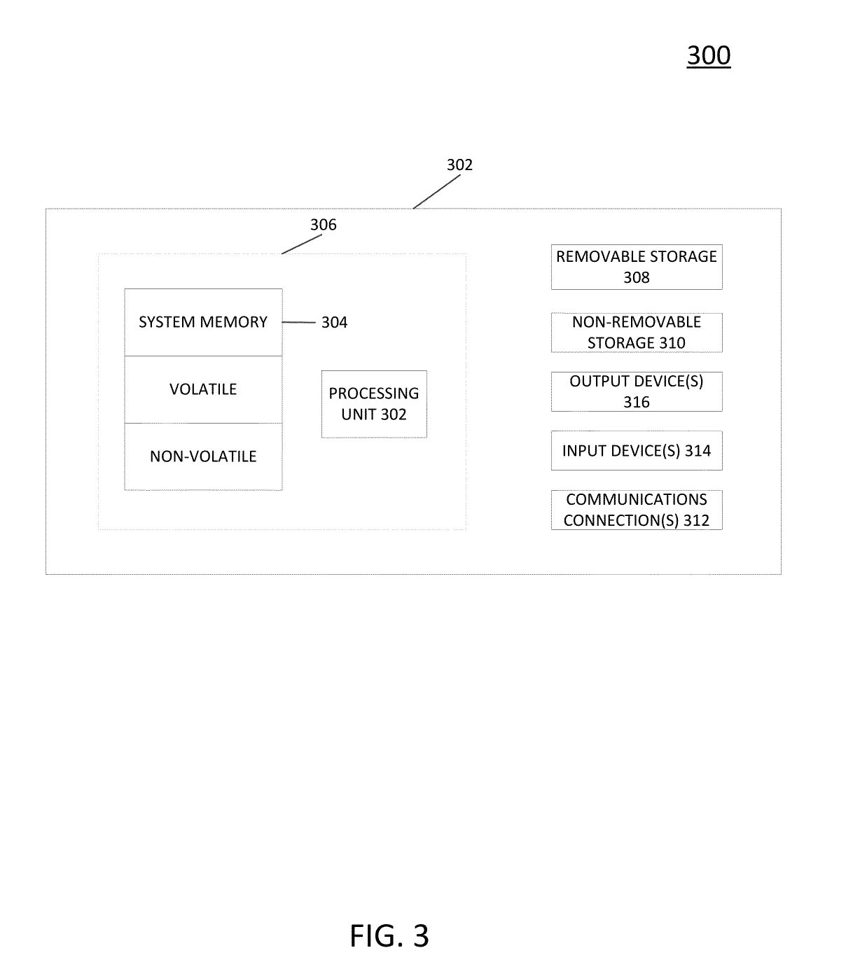

Referring now to FIG. 2A, depicted is an exemplary system 200 for implementing embodiments of the present invention. This exemplary system includes, inter alia, one or more computing devices 202 and server 220, which interface to each other via network 210. In its most basic configuration, as depicted in FIG. 3, computing device 202 includes at least one processing unit 302 and at least one memory 304. Depending on the exact configuration and type of the computing device, memory 304 may be volatile (such as random access memory (“RAM”)), non-volatile (such as read-only memory (“ROM”), flash memory, etc.), or some combination of the two. This most basic configuration is illustrated in FIG. 3 by dashed lines 306. In addition to that described herein, computing devices 202 can be any web-enabled handheld device (e.g., cell phone, smart phone, or the like) or personal computer including those operating via Android, Apple, and/or Windows mobile or non-mobile operating systems.

Computing device 202 may have additional features/functionality. For example, computing device 202 may include additional storage (removable and/or non-removable) including, but not limited to, magnetic or optical disks or tape, thumb drives, and external hard drives as applicable. Such additional storage is illustrated in FIG. 3 by removable storage 308 and non-removable storage 310.

Computing device 202 typically includes or is provided with a variety of computer-readable media. Computer-readable media can be any available media that can be accessed by computing device 202 and includes both volatile and non-volatile media, removable and non-removable media. By way of example, and not limitation, computer-readable media may comprise computer storage media and communication media.

Computer storage media includes volatile and non-volatile, removable and non-removable media implemented in any method or technology for storage of information such as computer-readable instructions, data structures, program modules or other data. Memory 304, removable storage 308, and non-removable storage 310 are all examples of computer storage media. Computer storage media includes, but is not limited to, RAM, ROM, electrically erasable programmable read-only memory (“EEPROM”), flash memory or other memory technology, CD-ROM, digital versatile disks (“DVD”) or other optical storage, magnetic cassettes, magnetic tape, magnetic disk storage or other magnetic storage devices, or any other medium which can be used to store the desired information and which can accessed by computing device 202. Any such computer storage media may be part of computing device 202 as applicable.

Computing device 202 may also contain communications connection 312 that allows the device to communicate with other devices. Such communications connection 312 is an example of communication media. Communication media typically embodies computer-readable instructions, data structures, program modules and/or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (“RF”), infrared and other wireless media. The term computer-readable media as used herein includes both storage media and communication media.

Computing device 202 may also have input device(s) 314 such as keyboard, mouse, pen, voice input device, touch input device, etc. Output device(s) 316 such as a display, speakers, printer, etc. may also be included. All these devices are generally known to the relevant public and therefore need not be discussed in any detail herein except as provided.

Notably, referring back to FIG. 2A, computing device 202 is one of a plurality of computing devices 202 inter-connected by network 206. As may be appreciated, network 206 may be any appropriate network and each computing device 202 may be connected thereto by way of connection 312 in any appropriate manner, and each computing device 202 may communicate with one or more of the other computing devices 202 via network 206 in any appropriate manner. For example, network 206 may be a wired network, wireless network, or a combination thereof within an organization or home or the like, and may include a direct or indirect coupling to an external network such as the Internet or the like. Likewise, network 206 may be such an external network including, without limitation, the Internet.

Computing device 202 may connect to server 208 via such an internal or external network. Although FIG. 2 depicts computing device 202 located in close proximity to server 208, this depiction is not intended to define any geographic boundaries. For example, when network 206 is the Internet, computing device can have any physical location. For example, computing device may be a tablet, cell phone, personal computer, or the like located at any user's office, home, a performance venue for the talent, etc. Or computing device could be located proximate to server 208 without departing from the scope hereof. Also, although FIG. 2A depicts computing devices 202 coupled to server 208 via network 206, computing devices may be coupled to server 208 via any other compatible networks including, without limitation, an intranet, local area network, or the like.

The depicted embodiment of system 200 uses a standard client server technology architecture, which allows users of system 200 to access information stored in the relational databases 210a, 210b, and 210c via custom user interfaces. The application is hosted on a server such as server 208 which is accessible via the Internet using a publically addressable Uniform Resource Locator (“URL”). For example, users can access exemplary system 200 using any web-enabled device equipped with a web browser. Communication between software component and sub-systems are achieved by a combination of direct function calls, publish and subscribe mechanisms, stored procedures, and direct SQL queries, however, alternate components, methods, and/or sub-systems may be substituted without departing from the scope hereof.

In some embodiments, server 220 is an Edge R200 server as manufactured by Dell, Inc., however, alternate servers may be substituted without departing from the scope hereof. System 200 and/or server 220 utilize a PHP scripting language to implement the processes described in detail herein. However, alternate scripting languages may be utilized without departing from the scope hereof.

The exemplary embodiment of the present invention utilizes a Linux variant messaging subsystem. However, alternate messaging subsystems may be substituted including, without limitation, a Windows Communication Foundation (“WCF”) messaging subsystem of a Microsoft Windows operating system utilizing a .NET Framework 3.0 programming interface. Also, in the depicted embodiment, computing device 202 interacts with server 208 via a Transmission Control Protocol/Internet Protocol (“TCP/IP”) communications protocol; however, other communication protocols may be substituted.

Computing devices 202 are equipped with one or more Web browsers to allow them to interact with server 208 via a HyperText Transfer Protocol (“HTTP”). HTTP functions as a request-response protocol in client-server computing. For example, a web browser operating on computing device 202 may execute a client application that allows it to interact with applications executed by server 208. The client application submits HTTP request messages to the server. Server 208, which provides resources such as HTML files and other content, or performs other functions on behalf of the client application, returns a response message to the client application upon request. The response typically contains completion status information about the request as well as the requested content. However, alternate methods of computing device/server communications may be substituted without departing from the scope hereof.

In the exemplary system 200, server 220 includes three databases, namely, email campaign database 210a, e-mail recipient database 210b, and ad campaign database 210c. However, alternate embodiments are envisioned in which all three databases are included in a single database, more than three databases are included, and/or the databases are combined or separated in a different manner than depicted. Each database may include a plurality of database tables. As may be appreciated, database(s) 210 may be any appropriate database(s) capable of storing data and may be included within or connected to server 208 or any plurality of servers similar to 208 in any appropriate manner without departing from the scope hereof.

In the exemplary databases of the present invention depicted in FIGS. 2B through 2D, database(s) 210 are structured query language (“SQL”) database(s) with a relational database management system, namely, MySQL as is commonly known and used in the art. Database(s) 210 are resident within server 208. However, other databases may be substituted without departing from the scope of the present invention including, but not limited to, PostgreSQL, Microsoft® SQL Server 2008 MySQL, Microsoft® Access®, and Oracle databases, and such databases may be internal or external to server 208. Also, server 208 may be any quantity of servers located in one or more locations as desired by the user to implement the systems and methods of the present invention. That is, the functions and/or databases associated with server 208 may be split between a plurality of servers as is known in the art.

It should be understood that the various techniques described herein may be implemented in connection with hardware or software or, as appropriate, with a combination of both. Thus, the methods and apparatus of the presently disclosed subject matter, or certain aspects or portions thereof, may take the form of program code (i.e., instructions, scripts, and the like) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter.

In the case of program code execution on programmable computers, the interface unit generally includes a processor, a storage medium readable by the processor (including volatile and non-volatile memory and/or storage elements), at least one input device, and at least one output device. One or more programs may implement or utilize the processes described in connection with the presently disclosed subject matter (e.g., through the use of an application-program interface (“API”), reusable controls, or the like). Such programs may be implemented in a high-level procedural or object-oriented programming language to communicate with a computer system. However, the program(s) can be implemented in assembly or machine language, if desired. In any case, the language may be a compiled or interpreted language, and combined with hardware implementations.

Although exemplary embodiments may refer to utilizing aspects of the presently disclosed subject matter in the context of one or more stand-alone computer systems, the subject matter is not so limited, but rather may be implemented in connection with any computing environment, such as system 200 or a distributed computing environment. Still further, aspects of the presently disclosed subject matter may be implemented in or across a plurality of processing chips or devices, and storage may similarly be effected across a plurality of devices in system 200. Such devices might include personal computers, network servers, and handheld devices (e.g., cell phones, tablets, smartphones, etc.), for example.

In the exemplary embodiment, server 220 and its associated databases are programmed to execute a plurality of processes including those shown in FIGS. 1, 4, 7, 8, 9A-9D, and 10 as discussed in greater detail below.

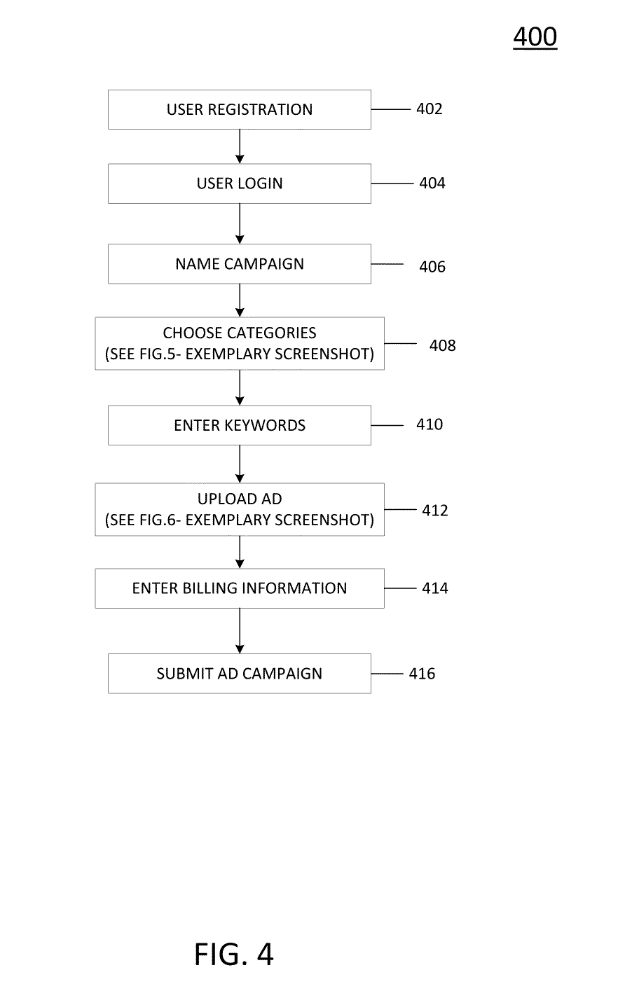

Turning now to FIG. 4, depicted is a flowchart of one exemplary method for allowing a user to create an advertising campaign in accordance with one embodiment of the present invention. Process 400 begins at 402, at which the advertiser-user registers with the email marketing advertising system. Such registration is performed as is known in the art and includes entry of the advertiser-user's information (e.g., first name, last name, and e-mail address) and selection by the user of a login name and password. After receipt of such information by the e-mail marketing system, the information is saved in a database table such as Users Table 222a, the advertiser-user's account is activated, and a confirmation e-mail is sent to the advertiser-user to confirm same. Process 400 then proceeds to 404.

At step 404, the advertiser-user logs in by entering, for example, a username and password as is known in the art. This information is validated via accessing the Users Table 222a as is also known in the art. Upon a successful login to the advertising system, the advertiser-user is able to create a new advertising campaign at step 406 by, for example, entering a campaign name and clicking a “Create” button or hyperlink. Process 400 then saves the selected campaign name in conjunction with the user identification information in a database table such as Campaigns Table 222b.

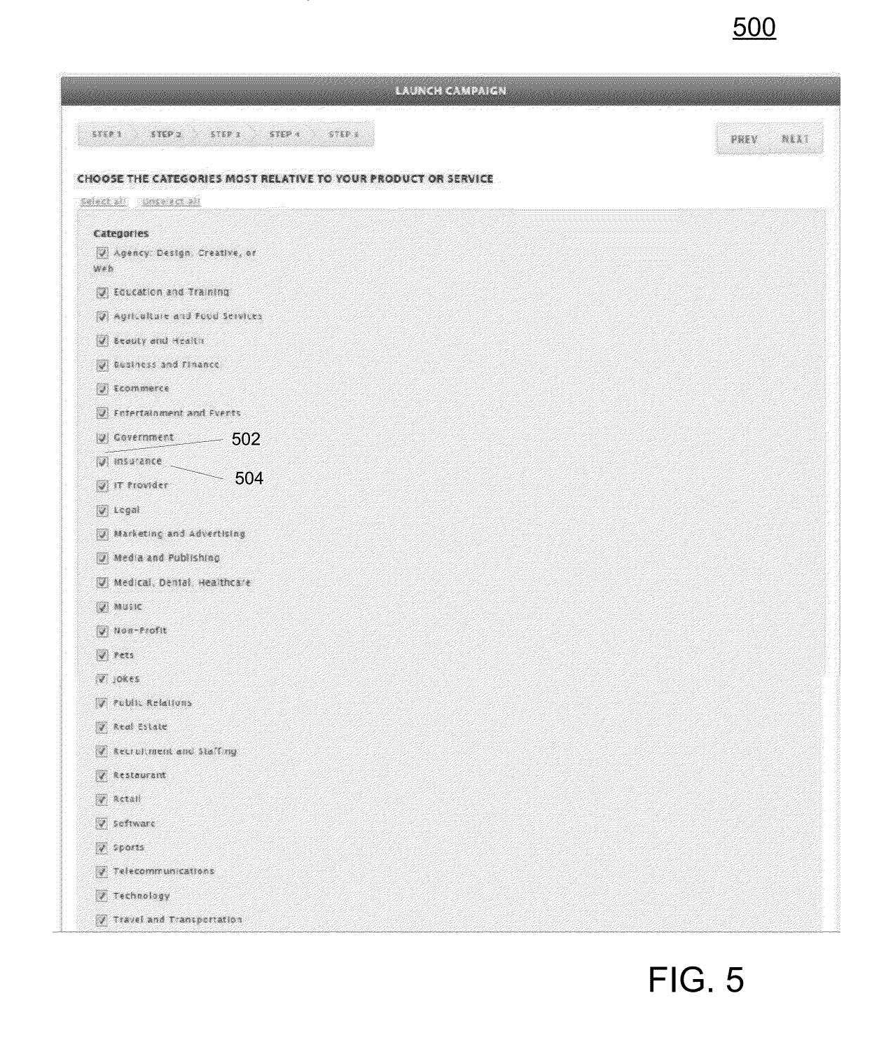

Process 400 then proceeds to 408 at which process 400 prompts the user to select categories for the user's ad campaign. An exemplary Web page for selecting one or more categories is shown in FIG. 5 and the Web page may be populated with the categories contained, for example, in Campaigns Table 222b. For example, in embodiments of the present invention utilizing a data entry Web page as shown in FIG. 5, the user simply selects the categories most relevant to the product or service to be advertised by clicking the box 502 to the left of the desired categories 504. However, alternate methods of selecting relevant categories may be substituted without departing from the scope hereof including embodiments in which the categories are auto-selected for the advertiser-user. After selection of the relevant categories, process 400 saves the selected categories in conjunction with the user identification information and campaign name in a database table such as Campaigns Table 222b and proceeds to step 410. In the depicted embodiment, each category selectable by the advertiser-user has an associated Category ID that is also saved in conjunction with the user identification information and campaign name in a database table such as Campaigns Table 222b, however, embodiments without Category IDs are also envisioned.

At 410, the advertiser-user enters keywords related to the advertising campaign being created. For example, in the depicted embodiment, up to five (5) keywords to identify the campaign may be manually entered by the user in a text entry box of a keyword data entry Web page. However, alternate methods of selecting keywords and/or alternate keyword quantities may be substituted without departing from the scope hereof including embodiments in which the keywords are auto-selected for the advertiser-user. After entry of the relevant keywords, process 400 saves the selected keywords in conjunction with the user identification information and other campaign information in a database table such as Campaigns Table 222b and proceeds to step 412.

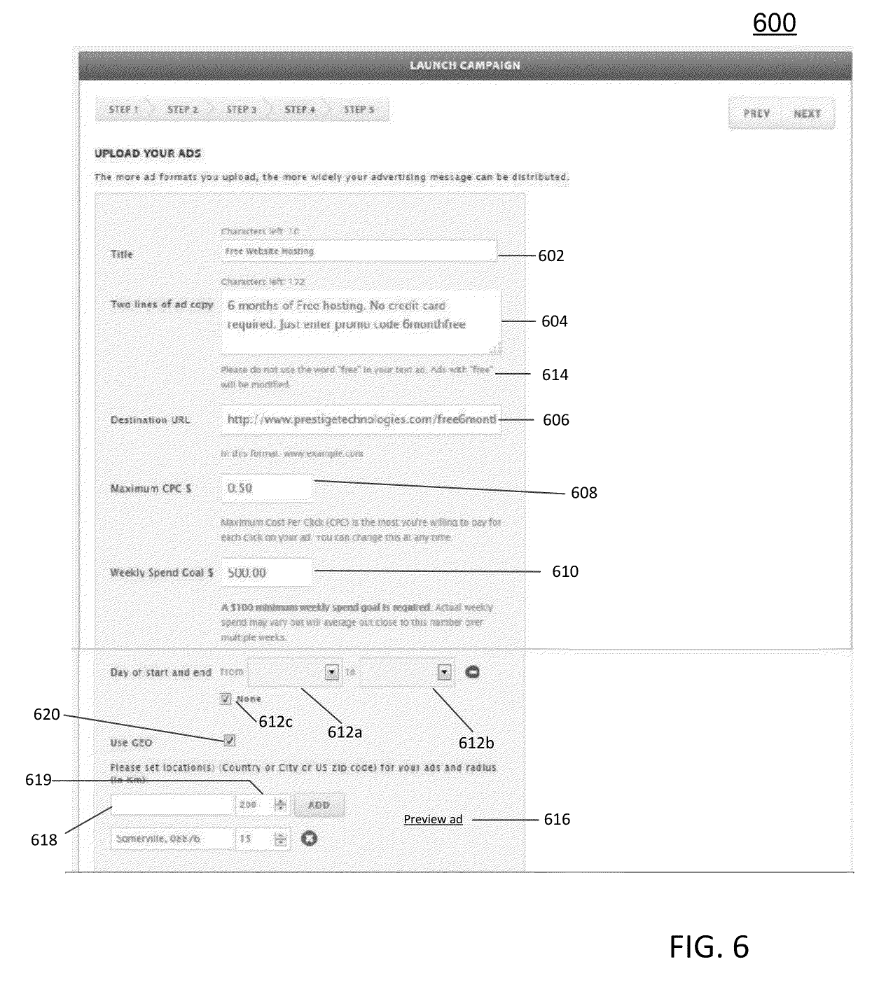

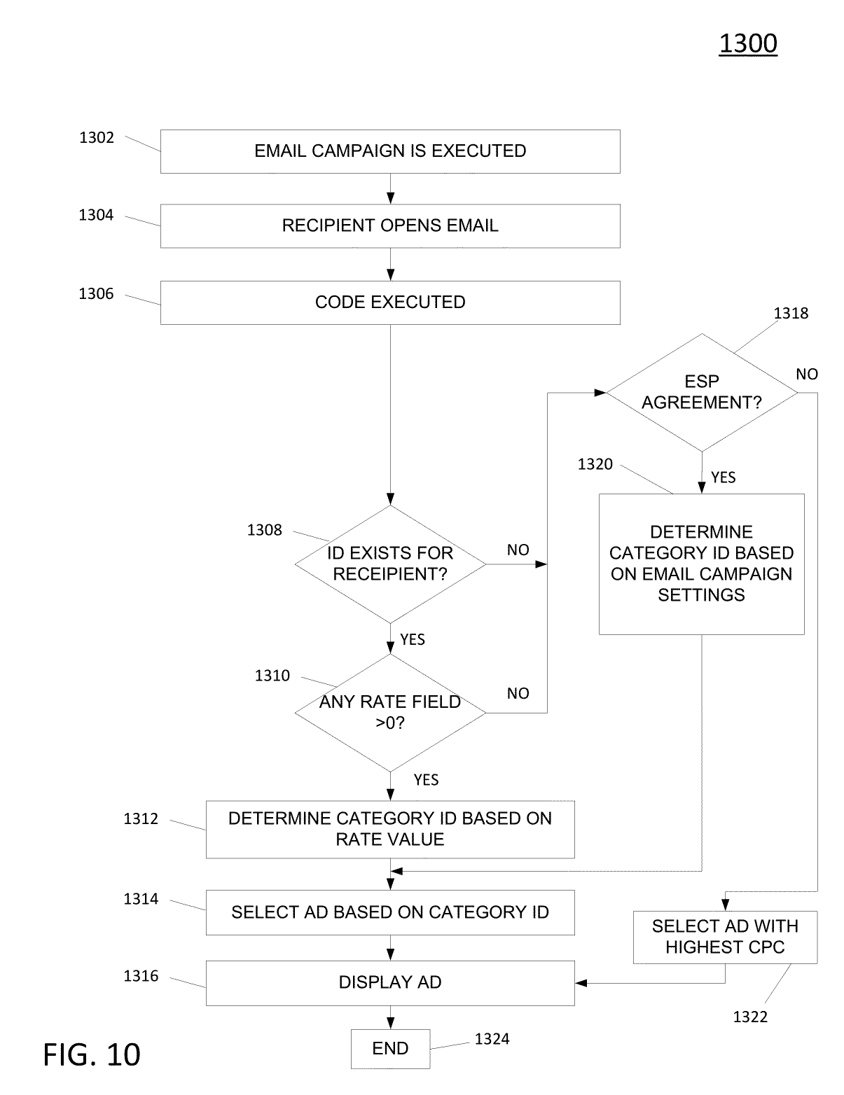

At 412, process 400 prompts the user to enter additional information for the advertiser-user's ad campaign. An exemplary Web page for entering the additional information is shown in FIG. 6. For example, in embodiments of the present invention utilizing a data entry Web page as shown in FIG. 6, the user is provided with text entry fields to accept the following information to complete the advertisement creation process: advertisement title field 602; advertisement copy field 604; destination URL field 606; maximum Cost Per Click (“CPC”) field 608; weekly spending goal field 610; campaign start date 612a; campaign end date 612b (or the user can elect no start and stop date by selecting none 612c); and geographic location 618. In the depicted embodiment, the data is manually entered by the user in a text entry box; however, alternate data entry methods may be substituted without departing from the scope hereof. Also, in the depicted embodiment, the advertiser-user is creating a text-only advertisement. However, in the alternate embodiment described herein with regards to FIG. 10, the advertiser-user is able to create a graphical advertisement. In such an embodiment, the graphical images to be displayed may be uploaded or otherwise provided to Advertisements Table 222e of Ad Campaign Database 210c at step 412.

More specifically, in the depicted embodiment of the present invention, advertisement title field 602 and advertisement copy field 604 accept a title selected by the user and a maximum of two lines of ad copy (e.g., ad content). In some embodiments of the present invention, instructions 614 regarding limitations of the title or ad copy to be entered by the advertiser-user may be displayed near such data entry boxes to instruct the advertiser-user regarding what content is or is not allowed.

The title and ad copy are displayed to the recipient of the advertisement appended emails as shown, for example, in FIG. 1B. That is, the advertisement title 140 and copy 142 selected by the user may be displayed, for example, in an advertisement 144 located to the right of the content sent via email (e.g., a newsletter, holiday greeting, company announcement, etc.) by a traditional email marketing system as shown in FIG. 1B. Although the depicted embodiment allows entry of text only, alternate embodiments are envisioned in which non-text data may also be entered including, without limitation, graphics, logos, pictures, etc. The inclusion and display of graphical advertisements is discussed in greater detail below with regards to step 714 of FIG. 7 and FIG. 10. Also, although the depicted embodiment shows three advertisements located to the right of the content sent via email, alternate quantities of advertisements and alternate locations for the advertisements may be substituted without departing from the scope hereof. There is no limitation (other than practical limitations) with regards to the quantity and location of the advertisements (i.e., they are able to be located at any location within the email).

Referring back to FIG. 6, destination URL field 606 accepts a URL to which the recipient of the advertisement appended email will be directed if the user clicks or otherwise selects the advertiser-users advertisement. Maximum Cost Per Click (“CPC”) field 608 and weekly spending goal field 610 accept criteria relating to the monetary value the user is willing to pay for placing his or her advertisement including the maximum cost that the advertiser-user is willing to pay for a click or other selection of his or her advertisement and the maximum monetary value the advertiser-user is willing to pay per week for his or her advertisement. Although the depicted embodiment accepts CPC and a weekly budget, other financial parameters may be substituted without departing from the scope hereof (e.g., cost of sending the advertisement via email). Finally, campaign start date 612a and campaign end date 612b fields accept parameters of the timing of the advertisement campaign. Or, if the user does not wish to select a start and end date, the user may merely select None 612c. FIG. 6 shows some exemplary options to be selected during the ad creation process, however alternate options may be substituted including, without limitation, the ability to track the number of email opens and/or clicks associated with each advertisement for reporting to the advertiser-user.

In the depicted embodiment, a user can check the Use Geo box 620 to limit the geographic location to which the advertisement is disseminated. If the advertiser-user selects no to this option (i.e., does not check Use Geo box 620), the advertiser-user's advertisement will be disseminated to all geographic locations. If the advertiser-user selects yes to this option, process 400 prompts the advertiser-user to enter one or more geographic locations as a town/state combination, zip code, latitudinal/longitudinal coordinates, or the like as well as a radius in text boxes such as text boxes 618 and 619, respectively. When designated by the advertiser-user, the advertisement will only be transmitted to email recipients who are located within the radius of the zip code or other coordinates set by the advertiser-user. However, alternate methods of restricting the geographic location of the advertisements may be substituted without departing from the scope hereof. After entry of the limited geographic location, if any, process 400 saves the selected geographic location in conjunction with the other campaign information in a database table such as Campaigns Table 222b.

Also, in some embodiments of the present invention, a preview advertisement hyperlink 616 or the like is included to allow the advertiser-user to preview the advertisement prior to final submission of the advertising campaign. After entry of the additional campaign information, process 400 saves the selected information in conjunction with the user identification information and other campaign information in a database table such as Campaigns Table 222b and proceeds to step 414.

At 414, the advertiser-user enters billing information to allow the provider of the advertising system to bill the advertiser-user for execution of the advertising campaign. For example, in the depicted embodiment, a data entry Web page capable of receiving credit card information is present to the user. This Web page receives information regarding the credit card to be charged and the amount to be charged. In the depicted embodiment, the user is also able to select the following options: credit low reminder (i.e., the advertiser-user is sent an email when his or her available credit falls below 20% of the campaign budget); auto renewal (i.e., the advertiser-user's credit card is automatically charged when his or her available credit falls below 20% of the campaign budget); and save billing information (i.e., the advertiser-user may save the billing information to the advertising system database in order to prevent re-entry of same at a later date). However, alternate methods of accepting payment and/or alternate payment options may be substituted without departing from the scope hereof including, without limitation, PayPal®. After entry of the billing information, process 400 processes the payment as is known in the art and saves the payment information to a database table such as Bill History Table 222c. Also, if the advertiser-user has also selected auto-renewal, the advertiser-user's billing information and auto-renewal information is also saved in a database table such as Bill Recurring Table 222d, and process 400 proceeds to step 416. At 416, the advertiser-user submits the final advertising campaign for execution.

Once an advertising campaign has been created via, for example process 400, the advertisement is available for inclusion in an email to be sent along with email content intended for transmission via an email marketing system. More specifically, referring now to FIG. 1A, depicted is a flowchart of one process 100 for creating an email with both email content and integral advertisements for transmission via an email marketing system in accordance with one embodiment of the present invention. Also, FIG. 1B depicts an exemplary email 150 created by the method depicted in FIG. 1A which includes both email content 150 and one or more integral advertisements 144.

Process 100 begins at 102, after at least one email-user has created an email campaign (e.g., via the process shown and described with respect to FIG. 7), and the campaign has been saved in a database table such as Email Campaigns Table 224b as shown in FIG. 2B. At 102, a previously generated email campaign is about to be executed (i.e., the previously generated email content is about to be sent to a plurality of recipients via an email marketing system).

Next, process 100 proceeds to 104, at which it determines whether an advertisement will be packaged with the email content prior to transmission of the email content to a plurality of recipients. In the depicted embodiment of the present invention, this decision includes a query of a database table such as Email Users Table 224a (FIG. 2B) to determine if the creator of the email campaign (i.e., the email-user) has elected to allow advertisements to be packaged and transmitted with the user's email content. If the email-user has not elected this option, process 100 proceeds to step 106, at which the email content is sent without any advertisements. Process 100 then ends at 107.

Alternatively, if, at 104, the email-user has elected to allow advertisements to be packaged with his or her email content, process 100 proceeds to 105, at which advertisement keys are added to the email content. These keys are placeholders for the advertisements that will be inserted with the email content after selection of these advertisements in accordance with the processes of the present invention such as process 100 of the present invention. In the depicted embodiment, an exemplary key looks as follows:

<ul style=″padding:0;margin:0;width:200px;″>%Admailr_ADS1
%ADMAILR_ADS2 %ADMAILR_ADS3</ul>

However, alternate keys and/or methods of holding a place for advertisements to be later inserted may be substituted without departing from the scope hereof. Also, it should be noted that these keys and steps 104 through 120 are utilized for the sending of text-only advertisements. As discussed in greater detail below, in alternate embodiments of the present invention in which graphical advertisements are sent, such keys are not utilized. However, alternate embodiments are envisioned in which keys may be utilized for graphical advertisements also, such as being used as a placeholder for retrieval code.

Next, at 108, it is determined whether all recipients of the intended email campaign have been processed as described in greater detail below with respect to steps 110 through 120 of process 100. If all of the intended email recipients have been processed, process proceeds to 106 at which the email content and its appended text advertisements are transmitted to the recipients of the current email campaign. Process 100 then ends at 107.

If, at 108, there are email recipients who have not been processed, process 100 proceeds to 110 at which it determines whether an ID exists for the recipient. In the depicted embodiment, such determination is made by querying Recipients Table 226a of Email Recipient database 210b. That is, table 226a is searched for the recipient's email address to determine if the address is present and, if yes, to retrieve the recipient's corresponding recipient Email ID.

If a recipient Email ID exists, process 100 proceeds to step 114, at which the value of the rate field associated with the recipient Email ID (as stored in, for example, Recipients Table 226a) is queried to determine whether it is greater than zero. If the rate field value is greater than zero, process 100 proceeds to step 116, at which a category ID for the text advertisement(s) to be appended to the email content is determined based upon the value of the rate field. In the depicted embodiment, the Category ID is selected based upon the ID having the highest associated rate value. Also in the depicted embodiment, if two or more IDs have the same rate value, one of such IDs is selected at random. However, alternate embodiments are envisioned in which other ID criteria may be utilized to select one of the plurality of IDs having equal rate values.

Alternatively, if, at 110 a recipient Email ID does not exist, or if, at 114 the rate field associated with the recipient Email ID is not greater than zero, process 100 proceeds to step 112, at which a category ID for the advertisement is determined based upon the information selected by the emailer-user during creation of the email campaign. In the depicted embodiment, the category ID is selected by the emailer-user at step 714 of process 700 as described in greater detail below with respect to FIG. 7. However, alternate methods of obtaining a category ID may be substituted without departing from the scope hereof.

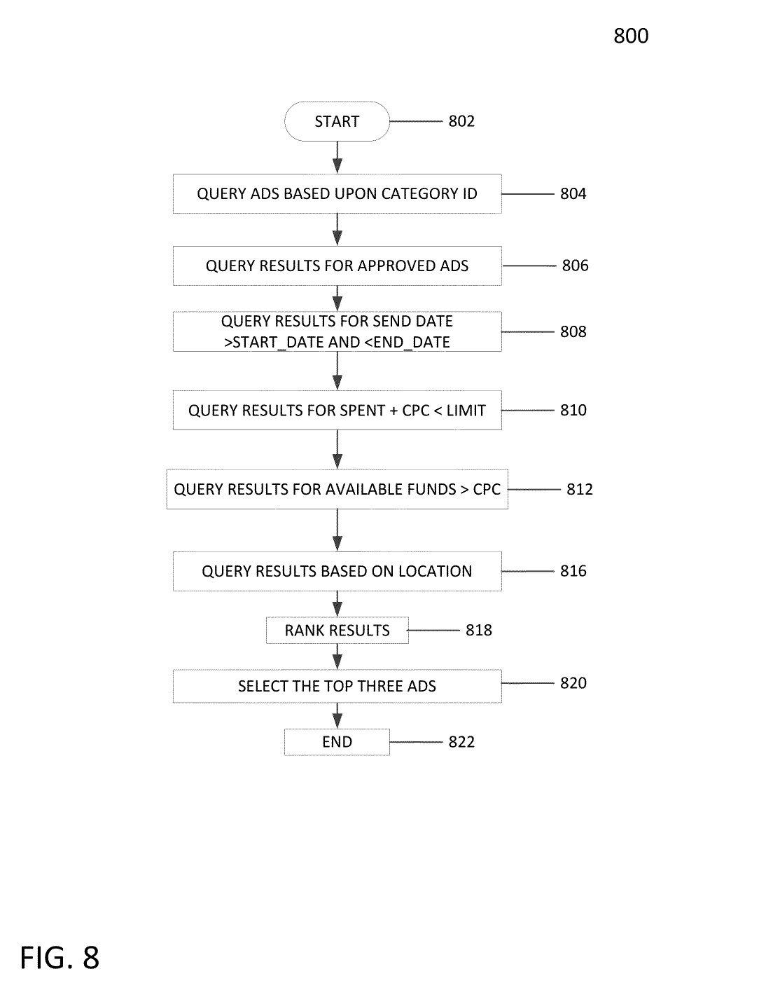

Once a category ID has been determined at step 112 or 116, process 100 proceeds to step 118 at which one or more advertisements are selected. The process of selecting the advertisements is described in greater detail below with regards to FIG. 8. Next, after the advertisement(s) have been selected, process 100 proceeds to 120, at which the emails to be sent are appended to include the content of the selected advertisement(s). That is, in the depicted embodiment, the respective advertisement key included in the email at step 105 is replaced with the corresponding % ADMAILR_ADS1, % ADMAILR_ADS2, or % ADMAILR_ADS3 data from Advertisements Table 222e. The creation of the latter is discussed below with respect to step 820.

For text advertisements, the advertisements are in.html format and are transmitted with the email content, which is also in.html format. In this manner, the text advertisements are pushed to the end recipient rather than being pulled after transmission of the email(s). However, alternate forms for the advertisements and/or email content may be substituted without departing from the scope of the present invention including, without limitation, graphical advertisements as discussed in greater detail herein. This content may be displayed, for example, to the right of the body of the email as shown in FIG. 1B. However, varying advertisement content locations may be substituted without departing from the scope hereof.

After the emails have been appended with the advertisement(s) content, process 100 returns to step 108, at which it determines whether all email recipients have been processed. If no, steps 108 through 120 are repeated. If yes, process 100 proceeds to 106 at which the emails (including email and text advertisement content) are sent to all recipients. Process 100 then ends at 107.

Turning now to FIG. 7, depicted is a flowchart of one exemplary method for allowing a user to create an email campaign in accordance with one embodiment of the present invention. Process 700 begins at 702, at which the emailer-user registers with the email marketing system. Such registration is performed as is known in the art and includes entry of the emailer-user's information (e.g., first name, last name, and e-mail address). After receipt of such information by the e-mail marketing system, the emailer-user's account is activated and a confirmation e-mail is sent to the emailer-user to confirm same. Process 700 then proceeds to step 704.

At step 704, the emailer-user chooses the Editor to be utilized to create the design, format, and/or content of the email to be transmitted to a plurality of recipients via an email marketing system. In the depicted embodiment, the user is able to select the editor from the following list of editors: HTML Editor, Template Designer, Pre-Designed Templates, Mobile Campaign Editor, and V4 Template Editor. However, alternate embodiments are envisioned in which alternate editors and/or editing/creation tools may be substituted without departing from the scope of the present invention.

The emailer-user selects a particular editor based upon how the user wishes to create the email. For example, if the emailer-user wishes to begin creating an email from scratch, the HTML Editor will accommodate this. Or, if the emailer-user wishes to choose from predefined template outlines in order to create a customized template, the Template Designer will allow this. Pre-Designed Templates allow the emailer-user to choose a design from the existing template library and customize it to fit his or her needs. Mobile Campaign Editor is chosen when the emailer-user wishes to create an email for mobile devices from scratch, and the V4 Template Editor is chosen when the emailer-user wishes to select a template from a predefined library. V4 Template Editor also guides the user through the process of creating the email without the need for HTML coding.

In addition to selecting the desired Editor, at 704, the emailer-user may also be prompted to enter additional information to customize the Editor prior to adding email content. For example, if the Pre-Designed Template Editor is chosen at step 704, the emailer-user is also prompted to select a template category (e.g., “Holidays”) and a particular template within that category (e.g., “Christmas” or “Hanukkah”). After all Template selections have been made, process 700 proceeds to 706.

At 706, the emailer-user enters a campaign name and clicks on a “Create” button or the like to officially create the new campaign. Next, at step 708, the emailer-user inputs the content of the text that will comprise the email campaign. For example, if the emailer-user is sending a Christmas or Hanukkah electronic card, the text may say “Merry Christmas and Happy New Year” or “Happy Hanukkah and a Happy New Year.” The emailer-user is also prompted to select one or more keywords to define the subject matter of the email campaign. However, alternate embodiments are envisioned in which the keywords are automatically assigned based upon the template selected by the user and/or the other information entered by the user. Process 700 then proceeds to 710.

At 710, the emailer-user clicks an “Apply” or “Preview” button or the like to preview the email created via steps 704 through 708. Next, at 712, if the emailer-user is satisfied with the generated e-mail, he or she proceeds to 714, at which the email is finalized. Alternatively, if the emailer-user is not satisfied with the generated email, he or she may return to steps 704 through 708 in order to edit the email as desired.

At step 714, the emailer-user customizes the email campaign by entering data to be associated with the plurality of transmitted email messages. For example, in the depicted embodiment, this data includes, but is not limited to: From (e.g., the name or e-mail address from which the email appears to be transmitted); Reply-To Address (e.g., the email address to which replies should be sent); Subject Line (the subject line of the e-mail); and Message Category (e.g., the type of subject matter referenced in the email). Some or all of this information may be manually entered, selected from a drop-down list of various choices, or entered in other similar manners. In the depicted embodiment of the present invention, the Message Category is selected from a predetermined category list. Each category is also associated with a Category ID. This Category ID is utilized, for example, in process 100 during the advertisement selection process as described in greater detail off above.

Also, at 714, if the emailer-user is opting to include advertisements in his or her email campaign, the emailer-user decides whether to include text or graphical advertisements. If the emailer-user wishes to include advertisements, the emailer-user adds the size and location of the advertisement(s) in his or her custom template selected at step 704 or the emailer-user selects a predefined template that includes space and sizing for an advertisement at step 704. If the user has elected to include graphical advertisements, retrieval code is added to the content of the email. This code, as described in greater detail below with regards to FIG. 10, will act to pull in the graphical display at the point that the email generated via process 700 is opened by the recipient thereof. In the depicted embodiment, if the user is not including graphical advertisements (e.g., the advertisements are text-only), then retrieval code is not added at step 714.

Next, process 700 proceeds to step 716, at which the emailer-user selects the recipients of the email. In the depicted embodiment, new recipients may be manually added or, for example, imported from an existing contact list. Or an existing, predefined recipient list may be selected. In the latter embodiment, if the emailer-user does not wish for one or more of the recipients in the predefined recipient list to receive the e-mail, he or she may designate addresses to be suppressed from the list.

After all of the recipients have been selected, process 700 proceeds to 718 at which the e-mail addresses associated with the recipients are verified. In the depicted embodiment, unverified email addresses are deleted from the list of recipients prior to transmission, and the emailer-user is notified of same via email or the like. Finally, process 700 proceeds to 720, at which the emails that are part of the generated email campaign are scheduled for delivery. For example, the emailer-user enters a start date and time and an end date and time during which he or she wishes to send the emails. Or, alternatively, the emailer-user can elect to send the campaign immediately by clicking, for example, a “Send Now” button or the like. Thereafter, process 700 ends at 722. If the email has been scheduled for delivery, the transmission of the emails is performed at the designated date and time using a process such as process 100 as depicted and described above with reference to FIGS. 1A and 1B. If the email campaign has been scheduled for immediate delivery, a process such as process 100 is immediately executed.

Referring now to FIG. 8, depicted is a flowchart of process 800, which is one method of automatically selecting advertisements to be appended to an email in accordance with one embodiment of the present invention. In the depicted embodiment, process 800 is executed, for example, at step 118 of process 100 as described in greater detail above with regards to FIG. 1A.

Process 800 begins at 802, after which one or more Category IDs have been determined. Such determination may have been performed by step 116 of process 100. However, alternate methods of determining category IDs may be substituted without departing from the scope hereof.

Next, at step 804, all advertisements associated with the Category ID determined in step 802 are queried to create a pool of potential advertisements to be appended to the emails transmitted via the email campaign (for text advertisements) or to be displayed to email recipients upon the opening of an email (for graphical advertisements). Process 800 then proceeds to 806 at which the pool of possible advertisements is queried to determine which advertisements are approved. For example, in the depicted embodiment, the content of each advertisement must be approved by an administrator of the advertising campaign to ensure that, for example, the advertisement content is sufficient to constitute an advertisement and that the content is within the guidelines of acceptable content. Any advertisements that have not been approved are eliminated from the pool of possible advertisements, and process 800 proceeds to 808.

At 808, the pool of possible advertisements is queried to determine acceptable transmission dates. These acceptable transmission dates are compared to the dates and times during which the e-mail campaign is to be executed. Any advertisements that have an acceptable transmission date/time that is later than the start date/time for the e-mail campaign and earlier than the end date/time for the e-mail campaign is retained in the pool of possible advertisements. All others are eliminated therefrom. However alternate embodiments are envisioned in which possible advertisements that partially overlap the time period for the e-mail campaign are still executed within the timing parameters of the advertisement. Process 800 then proceeds to 810.

At 810, the pool of possible advertisements is queried to determine whether the budget for each advertisement has exceeded its limit. Specifically, each possible advertisement is queried to determine whether the amount spent to date for total clicks on the advertisement during the current billing cycle plus the CPC value set by the advertiser-user is less than the advertising budget limit set by the advertiser-user. If this sum is not less than the advertising budget limit set by the advertiser-user, the advertisement is deleted from the pool of possible advertisements.

Next, at 812, process 800 queries each advertisement in the pool of possible advertisements to determine whether the advertiser-user's available funds are greater than the CPC value set by the advertiser-user. If no, the advertiser-user does not have the necessary credit to run his or her advertisement in the current e-mail campaign. Consequently, the advertisement is deleted from the pool of possible advertisements. If the advertiser-user has the necessary credit to run his or her advertisement, the advertisement is retained in the pool of possible advertisements and process 800 proceeds to 816.

Next, at 816, process 800 queries each advertisement in the pool of possible advertisements to determine whether the advertisement is limited to a specific geographic area and, if yes, whether the location of the current e-mail recipient is within the predetermined geographic area. More specifically, each advertisement in the pool of possible advertisements is queried to determine if the advertiser-user has selected the geography option. In such a scenario, the advertiser-user selects a geographic location during the advertisement creation process such as exemplary process FIG. 4. In the depicted embodiment, the geographic location may be inputted as a zip code or latitudinal/longitudinal coordinates as well as a radius. When designated by the advertiser-user, the advertisement will only be transmitted to email recipients who are located within the radius of the zip code or coordinates set by the advertiser-user. However, alternate methods of restricting the geographic location of the advertisements may be substituted without departing from the scope hereof.

The geographic location of the current email recipient is stored in Email Recipient Database 210b only if the recipient has previously received an email from the email marketing system. In such a scenario, if and when the email was opened by the recipient, the IP address associated with the recipient email was read and recorded in Email Recipient Database 210b in conjunction with the e-mail recipient's record. The registration location of the IP address is also saved in Email Recipient Database 210b in conjunction with the intended recipient's database record to allow process 800 to compare the advertiser's intended geographic location to the geographic location of the recipient at step 816. For each advertisement in the pool of possible advertisements, if the advertiser-user has not elected to limit the geographic location of the advertisement, the advertisement remains in the pool of possible advertisements. For those advertisements for which the advertiser-user has limited the geographic location, process 800 compares the geographical location of the current recipient's email address (as queried from Email Recipient Database 226a) to the geographical area set by the advertiser-user during the advertisement creation process. In one embodiment of the present invention, this comparison is performed using the MySQL SPATIAL function. More specifically, the request may be of a form such as, but not limited to:

SELECT * FROM geodata WHERE MBRContains
(LineString(Point(@lon +
100/(111.1/COS(RADIANS(@lat))),@lat +10/111.1), Point(@lon-
100/(111.1/COS(RADIANS(@lat))),@lat−100/111.1)), location);).

However, other methods of determining the geographic location of an email address and/or comparing same with a predetermined geographic location may be substituted without departing from the scope of the present invention. At 816, for each advertisement in the pool of possible advertisements for which the location of the current recipient's email address is not within the geographic location set by the advertiser-user, or if the recipient's email is not associated with a specific geographic location, the advertisement is deleted from the pool of possible advertisements.

Next, at 818, the advertisements remaining in the pool of possible advertisements are ranked based upon CPC and keyword relevance. For example, in the depicted embodiment, the advertisements are first ranked from high to low based upon the highest to lowest cost the advertiser is willing to pay per click, or CPC. Thereafter, for advertisements that have equal CPC, the advertisements' rankings are re-arranged within that subset of advertisements having equal CPC to place those with the most relevant keywords highest in ranking That is, the advertisements within the CPC subset that have the most keywords (as entered, for example, in step 410 of the advertisement creation process) that match the keywords associated with the email campaign to be transmitted (as entered, for example, in step 708 of the email campaign creation process) are ranked highest within the subset. Although the depicted embodiment ranks advertisements based upon CPC and keyword relevance, other ranking criteria may be added or substituted without departing from the scope of the present invention. Process 800 then proceeds to 820, at which the top three ranked advertisements are selected for appending to the emails to be sent in the email campaign, for example, as described above with respect to step 120 of FIG. 1A (for text advertisements) or for immediate display to the user (for graphical advertisements). In the depicted embodiment, for text advertisements, the selected advertisements are written to Ads Table 222e in, for example, the Ad Campaign database 210c utilizing fields such as db_subscriber id, ads1, ads2, ads3. These advertisements are later retrieved when the email is sent to the respective recipients as discussed above with respect to step 120 of FIG. 1A. Process 800 then ends at 822.

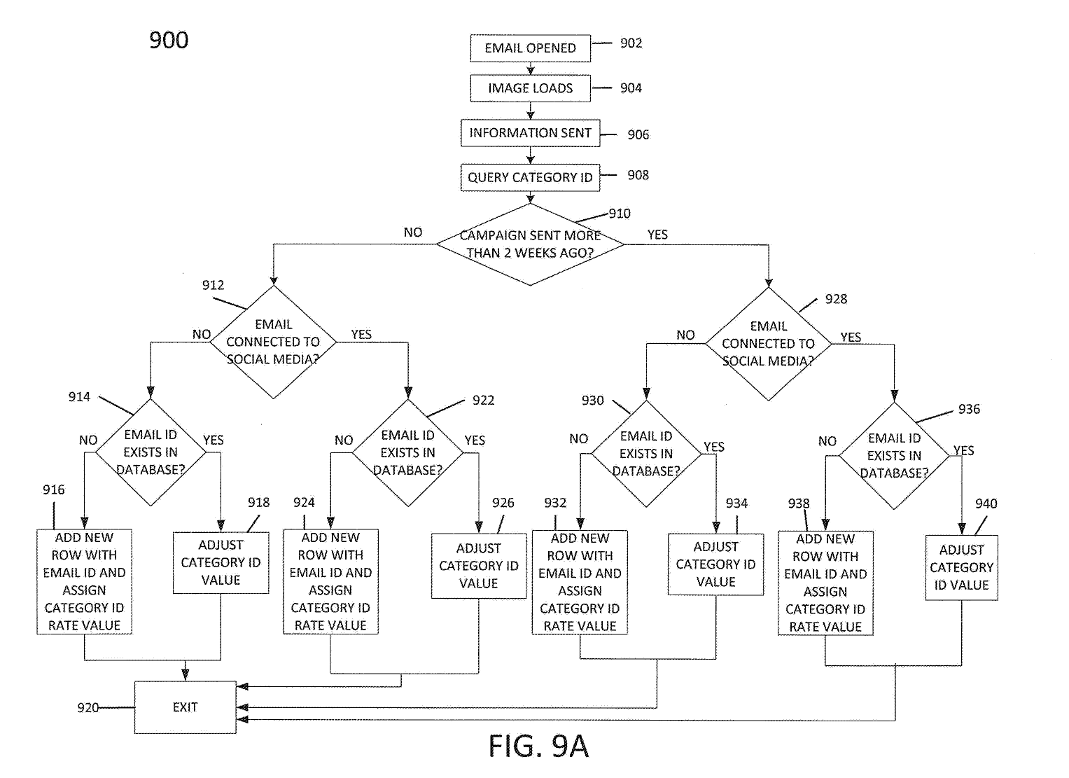

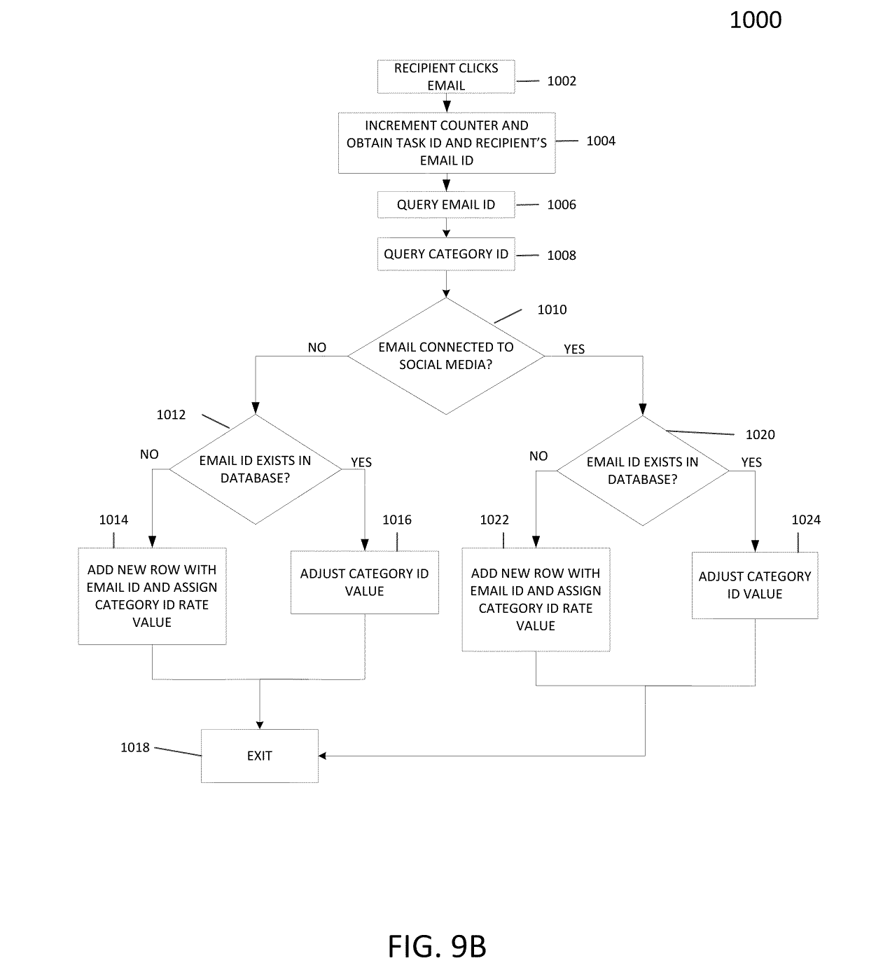

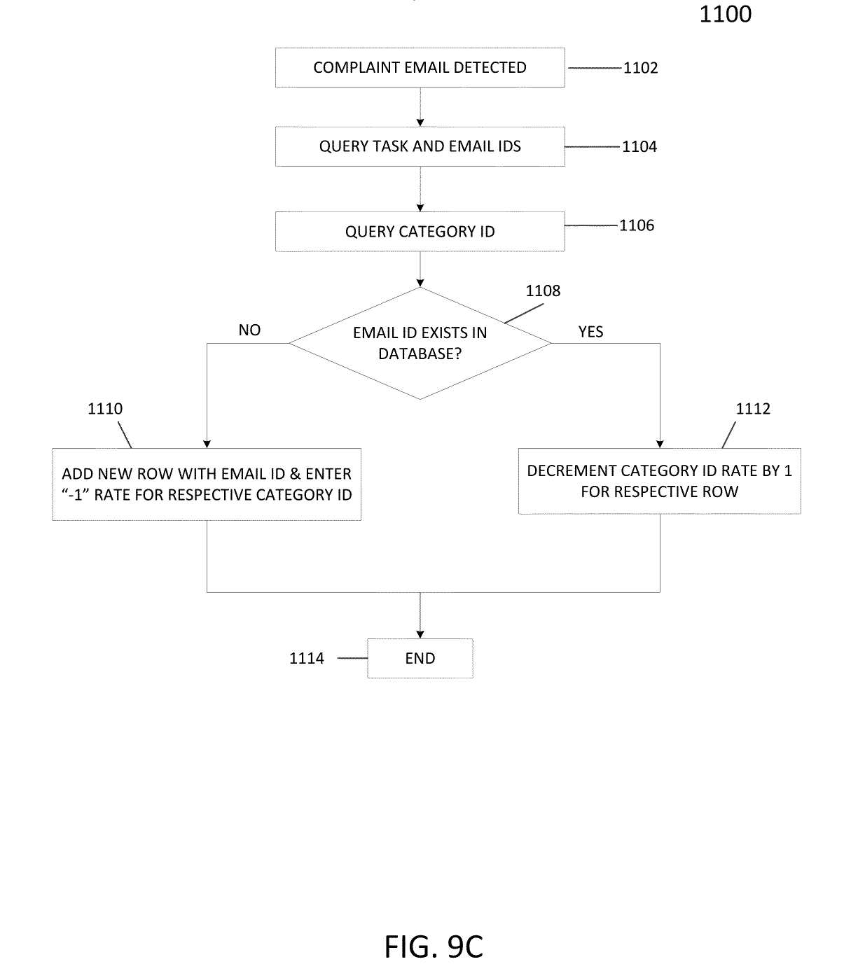

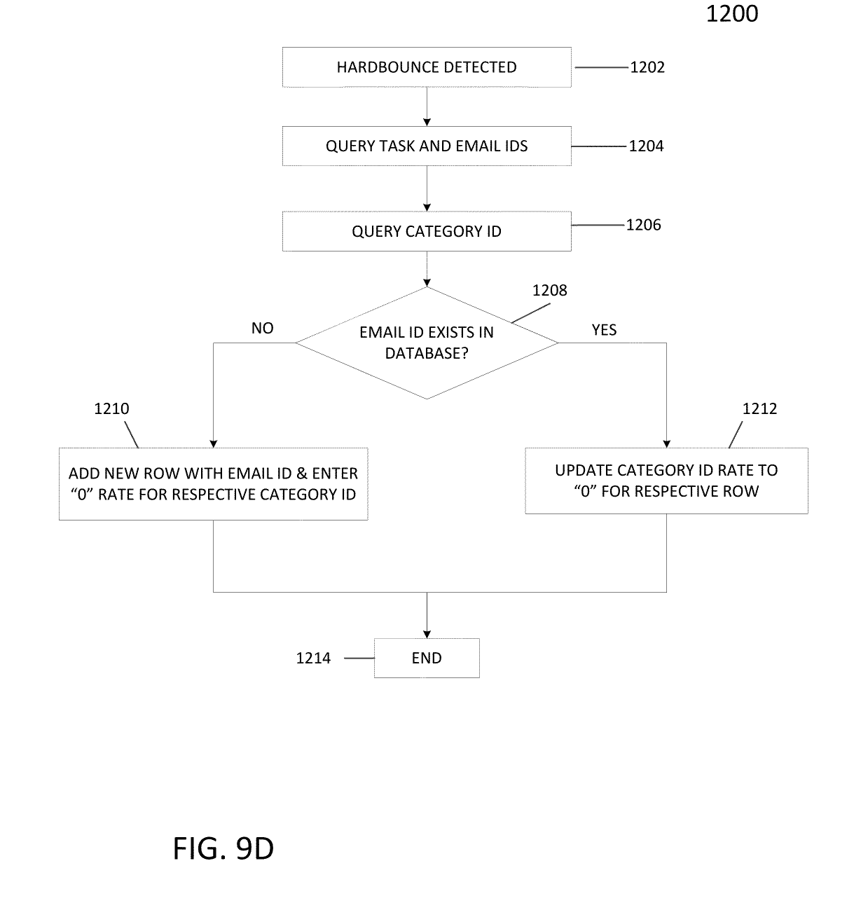

Turning next to FIGS. 9A through 9D, depicted are flowcharts of multiple methods of automatically updating a recipient's rate information in accordance with the depicted embodiment of the present invention. An individual email recipient's rate information may be utilized to determine the best advertisement Category ID for the specific email recipient as discussed in greater detail herein with respect to steps 114 and 116 of FIG. 1A and steps 1310 and 1312 of FIG. 10. That is, Email Recipient Database 210b includes one or more tables that associates each email recipient with a specific rate value for each Category ID. These rate values may be initially set to zero (i.e., the email recipient has no interest in the Category ID). However, based upon the actions of the email recipient and/or other criteria, these rate values may be updated to allow the systems and methods of the present invention to accurately select the advertisements that are most likely to be of interest to the email recipient, which thereby increases the effectiveness of the advertisements to be appended to, or displayed with, the emails in the email campaign.

Turning now specifically to FIG. 9A, depicted is a flowchart for adjusting the rate values of Category IDs based upon opened email data such as whether a user opens an email received via an email campaign. This allows future advertisements to be selected for a particular recipient based upon rate values associated with the email recipient that are modified based upon the emails that have been opened previously by that recipient (i.e., previously opened email data), which modification may be performed via a process such as process 900. Process 900 starts at 902, at which the recipient of an email sent via an email message campaign opens the email in his or her mail agent (e.g., Yahoo, Outlook, Gmail, etc.).

Process 900 then proceeds to 904, at which the opened email message includes an embedded image that is undetectable by the email recipient/viewer of the email. In the depicted embodiment, the image has zero width and height. The embedded image loads upon the opening of the email message by the recipient.

Next, process 900 proceeds to 906, at which the embedded image transmits information about the email recipient to Email Recipient Database 210b. In the depicted embodiment, the transmitted information includes an Email ID and a Task ID, both of which are sent as a GET parameter. More specifically, in the depicted embodiment, a pixel image such as http://panel.emercurymail.net/getpic.php?tid=XXX&cpid=YYY is utilized in which YYY is the recipient Email ID and YYY is the Task ID. The Email ID is an ID that is either assigned or associated with the email address to which the opened email was sent, and it is stored, for example, in Email Recipient Database 210b. The Task ID is associated with the type of email that was transmitted as part of the email campaign via which the opened email was sent. The Task ID is saved in Email Campaign database 210a in conjunction with information about the Email Campaign including, without limitation, the advertisement Category IDs sent to each email recipient. However, alternate methods of the obtaining and transmitting information and alternate types of information may be substituted without departing from the scope of the present invention.

In the depicted embodiment, the transmitted information also includes an instruction to increment all of the open counters associated with all of the advertisements included in the opened email. This instruction increments the “Open” counter associated with the respective advertisements, the value of which is stored in, for example, Campaigns Table 222b of Ad Campaign Database 210c. The “Open” counter indicates the number of times that an email containing the advertisement has been opened. However, alternate methods of maintaining “Open” counters and/or incrementing “Open” counters may be substituted without departing from the scope of the present invention. Process 900 then proceeds to 908.

At 908, the Task ID received from the opened email is utilized to obtain the Category ID associated with the email by cross-referencing Email Campaign Database 210a to determine the type of Category ID associated with the email that was sent to the specific email recipient (who opened the email) in correlation with the Task ID.

Process 900 then proceeds to 910, at which it determines whether the recently opened email was sent more than two weeks prior to opening. In the depicted embodiment, this is determined by comparing the current date to the date upon which the email campaign ran as stored and saved in Email Campaign Database 210a in association with the Task ID.

If, at 910, it is determined that the email was not sent more than two weeks prior to opening, process 900 proceeds to 912, at which process 900 determines whether the email recipient's email address is associated with a social media account (e.g., Facebook, Twitter, LinkedIn, G+, etc.). If no, process 900 proceeds to 914, at which process 900 queries the Preferences Table 226b of Email Recipient Database 210b to determine whether the Email ID of the email recipient exists in same. If no, process 900 proceeds to 916, at which a row is created for the Email ID and a rate value of three (3) is entered in the column associated with the Category ID associated with the opened email. Thereafter, process 900 proceeds to 920, at which it ends. Although a variety of specific rate values are suggested herein throughout the descriptions of FIGS. 9A through 9D, varying rate values may be substituted for any of the suggested rate values without departing from the scope hereof.

Alternatively, if at 914, process 900 determines that the Email ID of the email recipient exists in Preferences Table 226b, process 900 adds a value of three (3) to the value of the rate that is in the column associated with the Category ID associated with the opened email. That is, if the rate of the Category ID had never been edited, a value of three will be added to the current value of zero to create a new value of three. Alternatively, if the Category ID associated with the Email ID already had a value of, for example, five (5), the rate value will be updated from five (5) to eight (8). Thereafter, process 900 proceeds to 920, at which it ends.

Alternatively, if, at 912, it is determined that the email recipient's email address is associated with a social media account, process 900 proceeds to 922, at which process 900 queries the Preferences Table 226b of Email Recipient Database 210b to determine whether the Email ID of the email recipient exists in same. If no, process 900 proceeds to 924, at which a row is created for the Email ID and a rate value of five (5) is entered in the column associated with the Category ID associated with the opened email. Thereafter, process 900 proceeds to 920, at which it ends.

Alternatively, if at 922, process 900 determines that the Email ID of the email recipient exists in Preferences Table 226b, process 900 adds a value of five (5) to the value of the rate that is in the column associated with the Category ID associated with the opened email. That is, if the rate of the Category ID had never been edited, a value of five (5) will be added to the current value of zero to create a new value of five (5). Alternatively, if the Category ID associated with the Email ID already had a value of, for example, five (5), the rate value will be updated from five (5) to ten (10). Thereafter, process 900 proceeds to 920, at which it ends.

If, at 910, it is determined that the email was sent two weeks or more than two weeks prior to opening, process 900 proceeds to 928, at which process 900 determines whether the email recipient's email address is associated with a social media account. If no, process 900 proceeds to 930, at which process 900 queries the Preferences Table 226b of Email Recipient Database 210b to determine whether the Email ID of the email recipient exists in same. If no, process 900 proceeds to 932, at which a row is created for the Email ID and a rate value of two (2) is entered in the column associated with the Category ID associated with the opened email. Thereafter, process 900 proceeds to 920, at which it ends.

Alternatively, if at 930, process 900 determines that the Email ID of the email recipient exists in Preferences table 226b, process 900 adds a value of two (2) to the value of the rate that is in the column associated with the Category ID associated with the opened email. That is, if the rate of the Category ID had never been edited, a value of two (2) will be added to the current value of zero to create a new value of two (2). Alternatively, if the Category ID associated with the Email ID already had a value of, for example, five (5), the rate value will be updated from five (5) to seven (7). Thereafter, process 900 proceeds to 920, at which it ends.

Alternatively, if, at 928, it is determined that the email recipient's email address is associated with a social media account, process 900 proceeds to 936, at which process 900 queries the Preferences Table 226b of Email Recipient Database 210b to determine whether the Email ID of the email recipient exists in same. If no, process 900 proceeds to 938, at which a row is created for the Email ID and a rate value of four (4) is entered in the column associated with the Category ID associated with the opened email. Thereafter, process 900 proceeds to 920, at which it ends.

Alternatively, if at 936, process 900 determines that the Email ID of the email recipient exists in Preferences table 226b, process 900 adds a value of four (4) to the value of the rate that is in the column associated with the Category ID associated with the opened email. That is, if the rate of the Category ID had never been edited, a value of four (4) will be added to the current value of zero to create a new value of four (4). Alternatively, if the Category ID associated with the Email ID already had a value of, for example, five (5), the rate value will be updated from five (5) to nine (9). Thereafter, process 900 proceeds to 920, at which it ends.

Although the depicted process assigns different rate values depending upon the length of time required to open an email and whether the email is associated with a social media account, other criteria may be added or substituted without departing from the scope hereof. Also, different rate values may be substituted for each of the criteria without departing from the scope hereof.

Referring next to FIG. 9B, depicted is a flowchart of a process 1000 for adjusting the rate values of Category IDs based upon accessed advertisement data such as whether a user clicks a hyperlink embedded in an email received via an email campaign, for example, a hyperlink associated with one of the email's appended text or graphical advertisements. This allows future advertisements to be selected for a particular recipient based upon rate values associated with the email recipient that are modified based upon the emails that have been accessed previously by that recipient (i.e., previously accessed email data), which modification may be performed via a process such as process 1000.

Process 1000 starts at 1002, at which the recipient of an email sent via an email message campaign clicks a hyperlink embedded in the email or an advertisement appended thereto, after the email is opened in his or her mail agent (e.g., Yahoo, Outlook, Gmail, etc.). Clicking of the hyperlink opens a Web browser or the like and automatically directs the Web browser to a URL stored in the Ad Campaign Database 210c to allow this database to populate the recipient's Web page. This URL may be entered by the advertiser-user, for example, at step 412 of process 400 as described above.

Process 1000 then proceeds to 1004, at which Ad Campaign Database 210c increments the counter associated with the recently clicked hyperlink via execution of a Clicks Counter script embedded in the Web page. That is, the click counter associated with the clicked advertisement is incremented and the new click counter value is stored in, for example, the Campaigns Table 222b of the Ad Campaign Database 210c. The “Click” counter value indicates the number of times that the advertisement has been clicked. However, alternate methods of maintaining “Click” counters and/or incrementing “Click” counters may be substituted without departing from the scope of the present invention. The Clicks Counter script also obtains the Task Id and recipient's Email ID. However, alternate types of information may be obtained and/or other methods of obtaining information related to the hyperlink may be substituted without departing from the scope hereof. Incrementing of the clicks counter allows the systems and methods of the present invention to track the quantity of clicks on an individual advertisement basis in order to, inter alia, provide diagnostic reports and/or bill the advertiser-user for the total clicks based upon the predetermined CPC value.

Next, process 1000 proceeds to 1006, at which the Task ID (as defined above) and recipient's Email ID (as defined above) is utilized to obtain information about the email recipient from Email Recipient Database 210b. The Task ID and Email ID are saved in Email Campaign Database 210a in conjunction with information about the email campaign including, without limitation, the advertisement Category IDs sent to each email recipient. However, alternate methods of the obtaining and transmitting information and alternate types of information may be substituted without departing from the scope of the present invention. Process 1000 then proceeds to 1008.

At 1008, the Task ID received in the preceding steps is utilized to obtain the Category ID associated with the email by cross-referencing Email Campaign Database 210a to determine the type of Category ID associated with the email that was sent to the specific email recipient (who clicked the hyperlink) in correlation with the Task ID.

Process 1000 then proceeds to 1010, at which process 1000 determines whether the email recipient's email address is associated with a social media account. If no, process 1000 proceeds to 1012, at which process 1000 queries Preferences Table 226b of Email Recipient Database 210b to determine whether the Email ID of the email recipient exists in same. If no, process 1000 proceeds to 1014, at which a row is created for the Email ID and a rate value of four (4) is entered in the column associated with the Category ID associated with the clicked link. Thereafter, process 1000 proceeds to 1018, at which it ends.

Alternatively, if at 1012, process 1000 determines that the Email ID of the email recipient exists in Preferences table 226b, process 1000 adds a value of four (4) to the value of the rate that is in the column associated with the Category ID associated with the clicked link. That is, if the rate of the Category ID had never been edited, a value of four (4) will be added to the current value of zero to create a new value of four (4). Alternatively, if the Category ID associated with the Email ID already had a value of, for example, five (5), the rate value will be updated from five (5) to nine (9). Thereafter, process 1000 proceeds to 1018, at which it ends.

Alternatively, if, at 1010, it is determined that the email recipient's email address is associated with a social media account, process 1000 proceeds to 1020, at which process 1000 queries the Preferences Table 226b of Email Recipient Database 210b to determine whether the Email ID of the email recipient exists in same. If no, process 1000 proceeds to 1022, at which a row is created for the Email ID and a rate value of six (6) is entered in the column associated with the Category ID associated with the clicked link. Thereafter, process 1000 proceeds to 1018, at which it ends.

Alternatively, if at 1020, process 1000 determines that the Email ID of the email recipient exists in Preferences table 226b, process 1000 proceeds to 1024, at which it adds a value of six (6) to the value of the rate that is in the column associated with the Category ID associated with the clicked hyperlink. That is, if the rate of the Category ID had never been edited, a value of six (6) will be added to the current value of zero to create a new value of six (6). Alternatively, if the Category ID associated with the Email ID already had a value of, for example, five (5), the rate value will be updated from five (5) to eleven (11). Thereafter, process 1000 proceeds to 1018, at which it ends.

Turning now to FIG. 9C, depicted is a flowchart of a process 1100 for adjusting the rate values of Category IDs based upon whether an email recipient complains about receipt of the email that is part of the email campaign. Process 1100 starts at 1102, at which it detects that a complaint has been submitted by an email recipient. For example, such a complaint may be the clicking of an “Unsubscribe,” “Complaint,” “Junk,” or “Spam,” hyperlink or the like etc.) included in the email after the email is opened in the recipient's email agent. The Internet Service Provider (“ISP”) associated with the email agent receives the “Complaint” message from the email recipient and checks the source IP address for the email message that is subject to the complaint. Assuming that the IP address associated with the sender has registered an email address with the Feed Back Loop (“FBL”) of the respective ISP, the ISP sends the “Complaint” message to the registered email address.

Process 1100 then proceeds to 1104, at which the “Complaint” email message received from the ISP is parsed to determine the recipient's email address and the date and time at which the email was sent. This information is then utilized to obtain the Email ID and Task ID associated with the email that was the subject of the complaint. However, alternate types of information may be obtained and/or other methods of obtaining information related to the email recipient may be substituted without departing from the scope hereof.

Next, process 1100 proceeds to 1106, at which the Task ID (as defined above) and recipient's Email ID (as defined above) is utilized to obtain information about the email recipient from Email Recipient Database 210b. The Task ID and Email ID are saved in Email Campaign Database 210a in conjunction with information about the email campaign including, without limitation, the advertisement Category IDs sent to each email recipient. This allows process 1100 to obtain the Category ID associated with the email by cross-referencing Email Campaign Database 210a to determine the type of Category ID associated with the email that was sent to the specific email recipient (who opened the email and submitted the complaint) in correlation with the Task ID. However, alternate methods of the obtaining and transmitting information and alternate types of information may be substituted without departing from the scope of the present invention.

Process 1100 then proceeds to 1108, at which process 1100 queries the Preferences Table 226b of Email Recipient Database 210b to determine whether the Email ID of the email recipient exists in same. If no, process 1100 proceeds to 1110, at which a row is created for the Email ID and a rate value of negative one (−1) is entered in the column associated with the Category ID associated with the submitted complaint. Thereafter, process 1100 proceeds to 1114, at which it ends.

Alternatively, if at 1108, process 1100 determines that the Email ID of the email recipient exists in Preferences Table 226b, process 1100 subtracts a value of one (1) from the value of the rate that is in the column associated with the Category ID associated with the submitted complaint. That is, if the rate of the Category ID had never been edited, a value of negative one (−1) will be added to the current value of zero to create a new value of negative one (−1). Alternatively, if the Category ID associated with the Email ID already had a value of, for example, five (5), the rate value will be decremented from five (5) to four (4). Thereafter, process 1100 proceeds to 1114, at which it ends.

Referring now to FIG. 9D, depicted is a flowchart of a process 1200 for adjusting the rate values of Category IDs based upon whether a transmitted email encounters a hard bounce. A hard bounce is an email that is returned to the sender because the email recipient's email address is invalid. Process 1200 starts at 1202, at which it detects a hard bounce. For example, a hard bounce may be detected in a variety of ways including, without limitation, by checking the validity of the email address domain such as is known in the art. In the depicted embodiment, Unworkable Domains database 226c is utilized to maintain a list of invalid domain names and the domain of each email recipient's address is compared against database 226c as one method of detecting a hard bounce.

Process 1200 then proceeds to 1204, at which Ad Campaign database 210c obtains the Task ID and Email ID of the transmitted email that prompted the hard bounce. However, alternate types of information may be obtained and/or other methods of obtaining information related to the email recipient may be substituted without departing from the scope hereof.

Next, process 1200 proceeds to 1206, at which the Task ID (as defined above) and recipient's Email ID (as defined above) is utilized to obtain information about the email recipient from Email Recipient Database 210b. The Task and Email IDs are saved in Email Campaign Database 210a in conjunction with information about the email campaign including, without limitation, the advertisement Category IDs sent to each email recipient. This allows process 1200 to obtain the Category ID associated with the email by cross-referencing Email Campaign Database 210a to determine the type of Category ID associated with the email that encountered the hard bounce. However, alternate methods of the obtaining and transmitting information and alternate types of information may be substituted without departing from the scope of the present invention.

Process 1200 then proceeds to 1208, at which process 1200 queries the Preferences Table 226b of Email Recipient Database 210b to determine whether the Email ID of the email recipient exists in same. If no, process 1200 proceeds to 1210, at which a row is created for the Email ID and a rate value of zero (0) is entered in the column associated with the Category ID associated with the hard bounce. Thereafter, process 1200 proceeds to 1214, at which it ends.

Alternatively, if at 1208, process 1200 determines that the Email ID of the email recipient exists in Preferences Table 226b, process 1200 changes the value of the rate that is in the column associated with the Category ID to zero (0). That is, regardless of the current value of the rate of the Category ID, this rate value is overwritten to a value of zero (0). Thereafter, process 1200 proceeds to 1214, at which it ends.

Referring next to FIG. 10, depicted is a flowchart of one process 1300 for displaying a graphical advertisement within an email transmitted via an email marketing system in accordance with one alternate embodiment of the present invention. In the depicted alternate embodiment, a graphical advertisement can include any advertisement that is not text only.

Process 1300 begins at 1302, after an email campaign has been executed (i.e., the previously generated email content has been sent to a plurality of recipients via an email marketing system). One method of creating such a campaign is depicted in FIG. 7 as discussed above. A method of executing such a campaign with graphical advertisements only is depicted and described above with respect to steps 102, 104, 106 and 107 of FIG. 1A. That is, in the depicted embodiment of the present invention, when graphical advertisements are being sent rather than text-only advertisements, steps 105 through 120 of FIG. 1A are not executed when the email campaign is transmitted to its recipients.

Next, at 1304, one of the plurality of emails transmitted during step 1302 is opened by its respective recipient. Process 1300 then proceeds to 1306, at which the opening of the email causes the execution of retrieval code embedded in the email (as added, for example, at step 714 of process 700 as discussed in greater detail above).

One example of such retrieval code is as follows:

<!--Start Admailr Banner Code--><p><a
href=″http://panel.dev.admailr.com/bannergo.php?r=1412929554645&CONTACT=%TO_EMAI
L&ai=3&em=0″ target=″ _blank″ style=″text-decoration: none;″> <img
contenteditable=″false″ height=″50″
src=″http://panel.dev.admailr.com/banner.php?ban_type=BAN_BIG3&no_cache=14129295
54645&contact=%TO_EMAIL″ style=″background:#e2e2e2;″ width=″320″ /></a></p><!--
End Admailr Banner Code-->

Execution of this code causes a call to Email Recipient Database 210b, which includes information about the email recipient's email address (i.e., the recipient who opened the email at step 1304).

Next, at 1308, process 1300 determines whether an ID exists for the recipient. In the depicted embodiment, such determination is made by querying Recipients Table 226a of Email Recipient Database 210b. That is, table 226a is searched for the recipient's email address to determine if the address is present and, if yes, to retrieve the recipient's corresponding recipient Email ID.

If a recipient Email ID exists, process 1300 proceeds to step 1310, at which the value of the rate field associated with the recipient's Email ID (as stored in, for example, Recipients Table 226a) is queried to determine whether it is greater than zero. If the rate field value is greater than zero, process 1300 proceeds to step 1312, at which a category ID for the advertisement(s) to be displayed to the email recipient is determined based upon the value of the rate field. In the depicted embodiment, the Category ID is selected based upon the ID having the highest associated rate value. Also in the depicted embodiment, if two or more IDs have the same rate value, one of such IDs is selected at random. However, alternate embodiments are envisioned in which other ID criteria may be utilized to select one of the plurality of IDs having equal rate values.

Alternatively, if, at 1308 a recipient Email ID does not exist, or if, at 1310 the rate field associated with the recipient Email ID is not greater than zero, process 1300 proceeds to step 1318, at which it is determined whether the depicted system for sending emails with integral advertisement content is integrated to the email service provider (“ESP”) that is providing the interface in which the email was opened (at step 1304). If it is not, process 1300 proceeds to step 1322, at which an available advertisement having the highest CPC value is selected regardless of its Category ID.

Alternatively, if at 1318, the system is integrated to the respective ESP, process 1300 proceeds to 1320. At 1320, a category ID for the advertisement is determined based upon the information selected by the emailer-user during creation of the email campaign. For example, when the system is integrated to the ESP, the depicted embodiment utilizes code such as:

http://panel.dev.admailr.com/banner.php?ban_type=BAN_BIG3&no_cache=1412 929554645&contact=% TO_EMAIL&cat=1_{—}2_{—}3_{—}45_{—}55

in addition to the retrieval code discussed above with regards to step 714 of FIG. 7. In such a scenario, the proper code can be determined at step 714 because the emailer-user is required to identify which ESP will be utilized to send the email with integral graphical advertisement. However, alternate code may be substituted without departing from the scope hereof.

In the depicted embodiment, the category ID is selected by the emailer-user at step 714 of process 700 as described in greater detail below with respect to FIG. 7. However, alternate methods of obtaining a category ID may be substituted without departing from the scope hereof.

Once a category ID has been determined at step 1312 or 1320, process 1300 proceeds to step 1314, at which one or more advertisements are selected. The process of selecting the advertisements is described in greater detail below with regards to FIG. 8. Next, after the advertisement(s) have been selected, or if a random advertisement was selected at step 1322, process 1300 proceeds to 1316, at which the content of the selected advertisement(s) is transmitted through the ESP and displayed to the user. This content may be displayed, for example, to the right of the body of the email as shown in FIG. 1B. However, varying advertisement content locations may be substituted without departing from the scope hereof. Thereafter, process 1300 proceeds to 1324, at which it ends.

Although several processes have been disclosed herein as software, it may be appreciated by one of skill in the art that the same processes, functions, etc. may be performed via hardware or a combination of hardware and software. Similarly, although the present invention has been depicted as a hardwired system, these concepts may be applied to wireless systems and hybrid hardwired and wireless systems without departing from the scope of the present invention.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A system for creating and transmitting electronic mail with integral advertisements via an email marketing system comprising:
receiving email content from an emailer-user for transmission to a plurality of recipients;
receiving a plurality of advertisements from one or more advertiser-users;
selecting at least one preferred advertisement from said plurality of advertisements for
transmission or display with said email content to each of said plurality of recipients based upon predetermined criteria;
transmitting said electronic mail, said electronic mail including email content and said at
least one preferred advertisement or retrieval code associated with said at least one preferred advertisement;
monitoring activity of each of said plurality of recipients relative to said at least one preferred advertisement;
recording said activity in conjunction with an Email ID of each of said plurality of recipients; and
modifying said predetermined criteria based upon said activity.

2. A system according to claim 1, wherein said predetermined criteria includes at least one of the group consisting of rate values, keywords, and category IDs.

3. A method according to claim 2, wherein said rate values are based upon data selected from the group consisting of previously opened email data, previously accessed advertisement data, social media data, timing data, complaint data, and hardbounce data.

4. A method according to claim 1, wherein said at least one preferred advertisement is transmitted in HTML format.

5. A method according to claim 1, wherein the advertisement data for said at least one preferred advertisement is pulled via code executed upon opening of said electronic mail.
